(19) United States
(12) Patent Application Publication
(10) Pub. No.: US 2015/0339883 A1
(43) Pub. Date: Nov. 26, 2015

(54) GAMING MACHINE AND GAME CONTROL METHOD

(71) Applicants: Universal Entertainment Corporation, Tokyo (JP); Aruze Gaming America, Inc., Las Vegas, NV (US)

(72) Inventors: Hiroki MUNAKATA, Tokyo (JP); Kenji ENOKIDO, Tokyo (JP); Tatsuya TERANISHI, Tokyo (JP); Ryosuke TAKAHASHI, Tokyo (JP)

(21) Appl. No.: 14/715,699

(22) Filed: May 19, 2015

(30) Foreign Application Priority Data
May 20, 2014 (JP) 2014-104576

(51) Int. Cl. G07F 17/32; A63F 13/23

(52) U.S. Cl. CPC G07F 17/3225; A63F 13/23; G07F 17/3244

(57) ABSTRACT

There is provided a gaming machine and a game control method with a wider variation in the games run in the gaming machine to make the games more attractive by increasing the number of types of the random determination process for symbols to be displayed. The main CPU executes a symbol random determination for determining symbols to be displayed on the reel device M1, based on the symbol random determination table; displays the symbols determined on the reel device M1; awards a first payout based on the symbols 501 displayed on the reel device M1; executes a continued random determination different from the symbol random determination, which determines whether to display a predetermined symbol on the reel device M1; performs displaying of the predetermined symbol on the display device, based on the result; and awards a second payout based on the predetermined symbols 501 displayed on the reel device.

### CROSS REFERENCE TO RELATED APPLICATION

This application claims the benefit of Japanese Patent Application No. 2014-104576, filed on May 20, 2014, which application is incorporated herein by reference in its entirety.

### FIELD OF THE INVENTION

The present invention relates to a gaming machine and a game control method, configured to run a game which displays symbols on a display device, and in particular, the present invention relates to a gaming machine and a game control method having characteristics in random determination related to displaying of symbols.

### BACKGROUND OF THE INVENTION

A gaming machine in general randomly determines symbols to be displayed on a display device such as a mechanical reel device or a video reel device, based on a symbol random determination table, as disclosed in PTL1. Such a gaming machine then displays the symbols thus determined on the display device, and awards a payout based on the symbols displayed.

### CITATION LIST

### Patent Document

[PTL 1] Specification of Publication of U.S. Patent application No. 2010/0304821

### SUMMARY OF THE INVENTION

### Technical Problem

As mentioned hereinabove, in a traditional art, the random determination for symbols to be displayed is random determination of symbols themselves based on a symbol random determination table. Therefore, the game run in the gaming machine tends to be mundane without variation. For example, even if the gaming machine is capable of running a plurality of different types of games such as a normal game and a bonus game, these types of games tend to resemble to each other, because the type of random determination of the symbols to be displayed is the same in the games. Due to this, the games run in the gaming machine tend to be less entertaining.

Given the situation, it is an object of the present invention to provide a gaming machine and a game control method with a wider variation in the games run to make the games more attractive by increasing the number of types of the random determination process for symbols to be displayed.

### Technical Solution

To achieve the above object, a first aspect of the present invention is a gaming machine comprising a storage unit configured to store a symbol random determination table to which a plurality of types of symbols are registered, a display device, and a controller, the controller configured to execute the following steps of: (A) executing a first random determination for determining symbols to be displayed on the display device, based on the symbol random determination table; (B) displaying the symbols determined in the step (A) on the display device; (C) executing a second random determination different from the first random determination, which determines whether to display a predetermined symbol on the display device; (D) performing displaying of the predetermined symbol on the display device, based on the result of the step (C).

The above structure executes not only the first random determination for determining symbols, which is commonly done in gaming machines, but also the second random determination which determines whether to display a predetermined symbol. This way, there is an additional type of random determination executable for displaying of symbols. Increasing the number of types of random determination for symbol displaying makes games run in the gaming machine more interesting with wider variation.

Further, the above first aspect may be adapted so that the controller executes the steps of: (E) awarding a first payout based on the symbols determined in the step (A); and (F) awarding a second payout based on the predetermined symbol determined in the step (C).

With the above structure, a payout is awarded for each of the types of random determinations. This makes the game more interesting.

Further, the above first aspect may be adapted so that the controller repeats the step (C) until the predetermined symbol is determined as not to be displayed on the display device by the second random determination, and the step (D) and the step (F) are repeated by the number of times the step (C) is executed. Further, the above first aspect may be adapted so that the controller, when the steps (C), (D), (F) are to be repeated, executes the step (D) of an n-th (where n>0) time based on the result of the second random determination in the step (C) of the n-th time, and execute the step (F) of the n-th time based on the predetermined symbol determined in the step (C) of the n-th time.

With the above structure, the second payout is awarded repeatedly based on the results of the second random determination. The player therefore could obtain the second payout a number of times depending on the results of the second random determination. The above structure therefore could let the player enjoy being awarded a payout a number of times. Further, when the steps (C), (D), and (F) are executed in a single unit game, the second payout is awarded a number of times within a period of executing the single unit game. This keeps the player interested in the bonus game while the bonus game is executed.

Further, the gaming machine of the above first aspect may be adapted so that the steps (C), (D), and (F) are executed in a bonus game, and one bonus type is selected, from a plurality of bonus types associated with different amounts of payout, and set as a selected bonus type. In this case, the controller may award the second payout based on the amount of payout corresponding to the selected bonus type set in the step (F) Further, the above first aspect may be adapted so that the controller executes the steps of: (I) executing a third random determination every time the step (C) is executed, to determine whether to make a transition from the set selected bonus type to another bonus type associated with an amount of payout higher than the set selected bonus type; and

With the structure, the type of bonus and the amount of the second payout could change to a higher rank, depending on the result of the third random determination, in a single bonus game. This change causes a gradual heightening of the player's expectation from the bonus game.

Further, the above first aspect may be adapted so that the controller, in the step (I), the third random determination to determine whether to make a transition to said another bonus type is executed from execution of the step (C) for the second time and every time the step (C) is executed thereafter, and the third random determination is not executed in a period between execution of the step (C) for the first time to execution of the step (C) for the second time.

In the above structure, the third random determination is executed for the first time in the step (C) of the second time and thereafter. Therefore, with the expectation for a change of the bonus type and the amount of the second payout to a higher rank, the above structure causes a strong player's expectation for repetitive displaying of the predetermined symbol and awarding of the second payout.

Further, the gaming machine of the above first aspect may be adapted so that the step (C) is repeated until the predetermined symbol is determined as not to be displayed on the display device by the second random determination, and then the step (D) and the step (F) are repeated a number of times the step (C) is executed.

In the above structure, displaying of the predetermined symbol and awarding of the second payout are executed after the second random determination is repeated to determine a series of flow in a single bonus game (i.e., the number of times the predetermined symbol is displayed and the number of times the second payout is awarded). This way, displaying of the predetermined symbol and awarding of the second payout are smoothly repeated. Further, it is possible to select and execute an effect suitable for the series of flow of the single bonus game.

Further, the above first aspect may be adapted so that the step (C) is executed when a specific symbol is included in the symbols displayed in the step (B), and that the step (C) is a process of determining by the second random determination whether to display the specific symbol as the predetermined symbol on the display device. The plurality of bonus types each may be associated with the number of specific symbols and the display device may display the same number of specific symbols as the number associated with the set selected bonus type in the step (D).

With the above structure, the specific symbol serving as the trigger for running of the bonus game is displayed in the step (D) during the bonus game. This facilitates the player to grasp the timing of transition from the normal game to the bonus game. The above structure also enables a structure in which, during the bonus game, the number of specific symbols displayed in the step (D) gradually increases according to the results of the third random determination. This allows the player to grasp changes in the selected bonus type and the amount of second payout step by step to a higher rank.

The above described first aspect may be adapted so that a plurality of paylines are arranged in a symbol display area of the display device, and the plurality of paylines include at least three paylines aligned in a vertical direction. Further, the step (C) may be executed when a specific symbol is displayed in a position corresponding to at least one of the plurality of paylines, and that the step (C) may be a process of determining by the second random determination whether to display the specific symbol as the predetermined symbol on the display device. Further, in the step (D), the specific symbol may be displayed in a position corresponding to a payline out of the at least three paylines other than the uppermost or lowermost payline, and no specific symbol may be displayed in positions corresponding to the uppermost or lowermost payline.

With the above structure, even when the specific symbol serving as a trigger for a bonus game is displayed in any position corresponding to any of the plurality of paylines, the specific symbol in the step (D) is displayed in a position corresponding to a payline out of the three paylines other than the uppermost payline or the lowermost payline (i.e., payline nearby the middle). This way the specific symbol is displayed with a favorable visibility in the bonus game.

The plurality of different types of bonus may be associated with different modes of effects, respectively. Further, the controller may execute the step of (K) providing an effect associated with the set selected bonus type, prior to the step (D).

The above structure enables an indication effect for the amount of the second payout before the predetermined symbol is displayed or the second payout is awarded.

To achieve the above object, a second aspect of the present invention is a game control method for a gaming machine comprising a storage unit configured to store a symbol random determination table, a display device, and a controller, comprising the steps of: (A) executing a first random determination for determining symbols to be displayed on the display device, based on the symbol random determination table; (B) displaying the symbols determined in the step (A) on the display device; (C) executing a second random determination different from the first random determination, which determines whether to display a predetermined symbol on the display device; and (D) performing displaying of the predetermined symbol on the display device, based on the result of the step (C).

The above structure executes not only the first random determination for determining symbols, which is commonly done in gaming machines, but also the second random determination which determines whether to display a predetermined symbol. As described, there is an additional type of random determination executable. Increasing the number of types of random determination for symbol displaying makes games run in the gaming machine more interesting with wider variation.

### Advantageous Effects

The above described structure provides a gaming machine and a game control method with a wider variation in the games run in the gaming machine to make the games more attractive by increasing the number of types of the random determination process for symbols to be displayed.

### BRIEF DESCRIPTION OF THE DRAWINGS

The nature and mode of operation of the present invention will now be more fully described in the following detailed description of the invention taken with the accompanying drawing figures, in which:

FIG. 1 is an explanatory diagram showing a normal game process and a bonus game process in a slot machine.

FIG. 2 is an explanatory diagram of a functional flow of the slot machine.

FIG. 3 is a perspective view of the slot machine.

FIG. 4 is an explanatory diagram of a button layout of a control panel.

FIG. 5 is an electrical block diagram of the slot machine.

FIG. 6A is a diagram showing a symbol arrangement position corresponding to a second payline.

FIG. 6B is a diagram showing a symbol arrangement position corresponding to a first payline.

FIG. 6C is a diagram showing a symbol arrangement position corresponding to a third payline.

FIG. 6D is a diagram showing a symbol arrangement position corresponding to a fourth payline.

FIG. 6E is a diagram showing a symbol arrangement position corresponding to a fifth payline.

FIG. 7 shows a symbol random determination table.

FIG. 8A shows weights for symbols on each reel.

FIG. 8B shows weights for symbols on each reel.

FIG. 8C shows weights for symbols on each reel.

FIG. 8D shows weights for symbols on each reel.

FIG. 8E shows weights for symbols on each reel.

FIG. 8F shows weights for symbols on each reel.

FIG. 8G shows weights for symbols on each reel.

FIG. 9A is an explanatory diagram (part 1) of a bet button setting.

FIG. 9B is an explanatory diagram (part 2) of a bet button setting.

FIG. 10 is shows a payout table.

FIG. 11 shows a gaming machine setting.

FIG. 12 is an explanatory diagram of a feature game (bonus game).

FIG. 13A shows a continued random determination table used in the first time continued random determination.

FIG. 13B shows a continued random determination table used in the second time continued random determination.

FIG. 14A shows probabilities of winning a payout upgrading random determination from a payout for a 3 of a kind combination to that for a 4 of a kind combination.

FIG. 14B shows probabilities of winning a payout upgrading random determination from a payout for the 4 of a kind combination to that for a 5 of a kind combination.

FIG. 15A shows a bonus information table.

FIG. 15B is a diagram showing an example flow of the internal random determination and payout upgrading random determination.

FIG. 16A is an explanatory diagram of display on the reels.

FIG. 16B is an explanatory diagram of display on the reels.

FIG. 17A is an explanatory diagram of display on the reels.

FIG. 17B is an explanatory diagram of display on the reels.

FIG. 18A is an explanatory diagram of display on the reels.

FIG. 18B is an explanatory diagram of display on the reels.

FIG. 19 is a flowchart showing an example main process.

FIG. 20A is a flowchart showing an example bonus game process.

FIG. 20B is a flowchart showing an example bonus awarding process.

FIG. 21A is a diagram showing an example image of a normal game.

FIG. 21B is a diagram showing an example image of a normal game.

FIG. 22A is a diagram showing an example display at the time of transition from a normal game to a bonus game.

FIG. 22B is a diagram showing an example display at the time of transition from a normal game to a bonus game.

FIG. 22C is a diagram showing an example display at the time of transition from a normal game to a bonus game.

FIG. 22D is a diagram showing an example display at the time of transition from a normal game to a bonus game.

FIG. 22E is a diagram showing an example display at the time of transition from a normal game to a bonus game.

FIG. 23 is a diagram showing an example display of the bonus game, which occurs at the time of bonus game start.

FIG. 24A is a diagram showing an example display of the bonus game, which occurs when no winning is resulted from a payout upgrading random determination.

FIG. 24B is a diagram showing an example display of the bonus game, which occurs when no winning is resulted from a payout upgrading random determination.

FIG. 24C is a diagram showing an example display of the bonus game, which occurs when no winning is resulted from a payout upgrading random determination.

FIG. 25A is a diagram showing an example display of a bonus game, which occurs when the payout upgrading random determination results in upgrading from a payout for the 3 of a kind combination to that for the 4 of a kind combination, or from the payout for the 4 of a kind combination to that for the 5 of a kind combination.

FIG. 25B is a diagram showing an example display of a bonus game, which occurs when the payout upgrading random determination results in upgrading from a payout for the 3 of a kind combination to that for the 4 of a kind combination.

FIG. 25C is a diagram showing an example display of a bonus game, which occurs when the payout upgrading random determination results in upgrading from a payout for the 3 of a kind combination to that for the 4 of a kind combination.

FIG. 25D is a diagram showing an example display of a bonus game, which occurs when the payout upgrading random determination results in upgrading from a payout for the 3 of a kind combination to that for the 4 of a kind combination.

FIG. 25E is a diagram showing an example display of a bonus game, which occurs when the payout upgrading random determination results in upgrading from a payout for the 3 of a kind combination to that for the 4 of a kind combination.

FIG. 26A is a diagram showing an example display of a bonus game, which occurs when the payout upgrading random determination results in upgrading from a payout for the 4 of a kind combination to that for the 5 of a kind combination.

FIG. 26B is a diagram showing an example display of a bonus game, which occurs when the payout upgrading random determination in upgrading from a payout for the 4 of a kind combination to that for the 5 of a kind combination.

FIG. 26C is a diagram showing an example display of a bonus game, which occurs when the payout upgrading random determination in upgrading from a payout for the 4 of a kind combination to that for the 5 of a kind combination.

FIG. 26D is a diagram showing an example display of a bonus game, which occurs when the payout upgrading random determination in upgrading from a payout for the 4 of a kind combination to that for the 5 of a kind combination.

FIG. 27A is a diagram showing an example display of the bonus game, which occurs when the continued random determination is not won.

FIG. 27B is a diagram showing an example display of the bonus game, which occurs when the continued random determination is not won.

FIG. 27C is a diagram showing an example display of the bonus game, which occurs when the continued random determination is not won.

FIG. 28 shows an example effect image displayed on the upper image display panel.

FIG. 29 shows an example effect image displayed on the upper image display panel.

FIG. 30 shows an example effect image displayed on the upper image display panel.

### DESCRIPTION OF THE PREFERRED EMBODIMENTS

The following will describe an embodiment of the present invention with reference to figures. It should be noted that in the embodiment described below, a gaming machine of the present invention is applied to a slot machine configured to run a slot game, as a preferable embodiment of the present invention.

(Overview of Slot Machine)

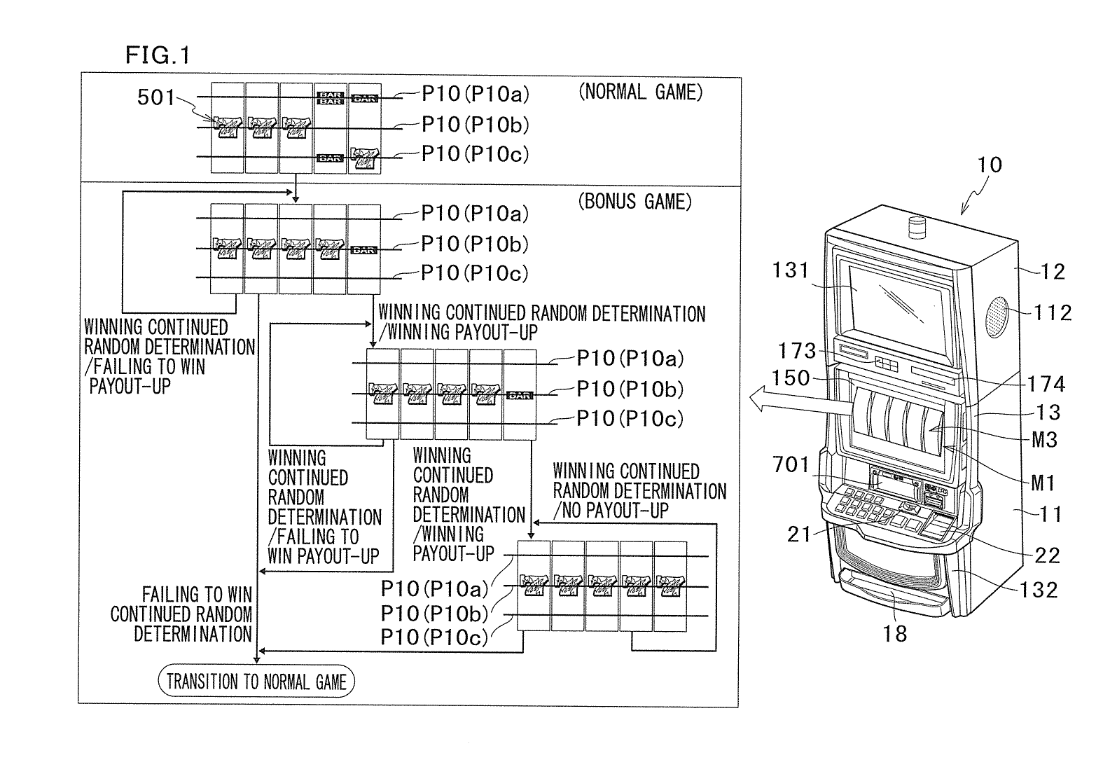

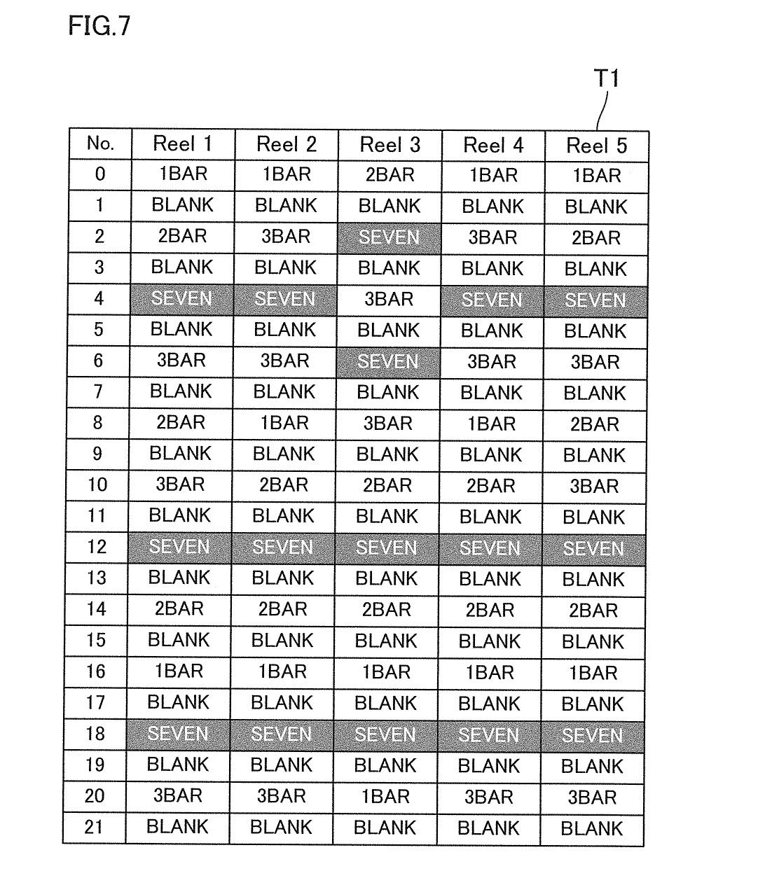

The following describes an overview of a slot machine 10 (gaming machine) related to the present embodiment, with reference to FIG. 1. The slot machine 10 includes: a memory card 54 or a RAM 73 (FIG. 5, storage unit) configured to store a symbol random determination table T1 (FIG. 7) to which a plurality of types of symbols 501 are registered, a reel device M1 (display device), and a main CPU 71 (FIG. 5, controller). The main CPU 71 is configured to execute (A) a symbol random determination process of executing a symbol random determination (first random determination) for determining symbols 501 to be displayed on the reel device M1, based on the symbol random determination table T1; (B) a displaying process of displaying the symbols 501 determined in the step (A) on the reel device M1; (C) a continued random determination process of executing a continued random determination (second random determination) different from the first random determination, which determines whether to display a predetermined symbol 501 (“SEVEN(7)” in the present embodiment) on the reel device M1; (D) a predetermined symbol displaying process of displaying the predetermined symbol 501 (“SEVEN(7)”) on the reel device M1, based on the result of the step (C).

The above structure executes not only the symbol random determination for determining symbols 501, which is commonly done in slot machines 10, but also the continued random determination which determines whether to display a predetermined symbol 501 (“SEVEN(7)”). This way, there is an additional type of random determination executable. Increasing the number of types of random determination makes games run in the slot machine 10 more interesting with wider variation. For example, by increasing the number of types of random determination for displaying symbols 501, it is possible to make games (normal game, bonus game) run in the gaming machine more interesting with wider variation.

Further, the main CPU 71 executes: (E) a payout process of awarding a first payout based on the symbols 501 displayed on the reel device M1 in the step (B); and (F) a second payout process of awarding a second payout based on the predetermined symbol 501 (“SEVEN(7)”) in the step (D).

With the above structure, a payout is awarded for each of the types of random determinations. This makes the game more interesting.

Further, the main CPU 71 repeats the step (C) until the predetermined symbol 501 (“SEVEN(7)”) is determined as not to be displayed on the reel device M1 by the continued random determination, and repeats the step (D) and the step (F) a number of times the step (C) is executed. Further, the CPU 71, when the steps (C), (D), (F) are to be repeated, executes the step (D) of an n-th (where n>0) time based on the result of the second random determination in the step (C) of the n-th time, and executes the step (F) of the n-th time based on the predetermined symbol 501 (“SEVEN(7)”) displayed in the step (D) of the n-th time.

With the above structure, the second payout is awarded repeatedly based on the results of the continued random determination. The player therefore could obtain the second payout a number of times depending on the results of the continued random determination. The above structure therefore could let the player enjoy being awarded a payout a number of times. Further, when the steps (C), (D), and (F) are executed in a unit game, the second payout is awarded a number of times within a period of executing the unit game. This keeps the player interested in the bonus game while the bonus game is executed. It should be noted that the above-mentioned unit game may be a unit bonus game or a unit normal game, in the present embodiment.

Further, in the slot machine 10, the steps (C), (D), and (F) are executed in a bonus game, and one bonus type (e.g., 3 of a kind combination of “SEVEN(7)”) is selected, from a plurality of bonus types (3 of a kind combination, 4 of a kind combination, or 5 of a kind combination of “SEVEN(7)”) associated with different amounts of payout, and set as a selected bonus type. Then, the main CPU 71 awards the second payout based on the amount of payout associated with the selected bonus type set in the step (F). Further, the main CPU 71 executes: (I) executing a payout upgrading random determination (third random determination) every time the step (C) is executed, to determine whether to make a transition from the set selected bonus type (e.g. 3 of a kind combination of “SEVEN(7)”) to another bonus type (4 of a kind combination of “SEVEN(7)” in this example) associated with an amount of payout higher than the set selected bonus type; and (J) setting the other bonus type as the selected bonus type when the transition to the other bonus type is determined as to be made in the payout upgrading random determination.

With the structure, the type of bonus and the amount of the second payout could change to a higher rank, depending on the result of the payout upgrading random determination, in a single bonus game. This change causes a gradual heightening of the player's expectation from the bonus game.

Further, the main CPU 71, in the step (I), the payout upgrading random determination to determine whether to make a transition to said another bonus type is executed from execution of the step (C) for the second time and every time the step (C) is executed thereafter, and the payout upgrading random determination is not executed in a period between execution of the step (C) for the first time to execution of the step (C) for the second time.

In the above structure, the payout upgrading random determination is executed after the step (C) of the second time, i.e., after the step (C) is repetitively executed. Therefore, with the expectation for a change of the bonus type and the amount of the second payout to a higher rank, the above structure causes a strong player's expectation for repetitive displaying of the predetermined symbol 501 (“SEVEN(7)”) and awarding of the second payout.

The slot machine 10 repeats the step (C) until the predetermined symbol 501 (“SEVEN(7)”) is determined as not to be displayed on the reel device M1 by the continued random determination, and then repeats the step (D) and the step (F) a number of times the step (C) is executed.

In the above structure, displaying of the predetermined symbol 501 (“SEVEN(7)”) and awarding of the second payout are executed after the continued random determination is repeated to determine a series of flow in a single bonus game (i.e., the number of times the predetermined symbol 501 (“SEVEN(7)”) is displayed and the number of times the second payout is awarded). This way, displaying of the predetermined symbol 501 (“SEVEN(7)”) and awarding of the second payout are smoothly repeated. Further, it is possible to select and execute an effect suitable for the series of flow of the single bonus game.

Further, the above first aspect may be adapted so that the step (C) is executed when a specific symbol 501 (“SEVEN(7)” in the present embodiment) is included in the symbols 501 displayed in the step (B), and that the step (C) is a process of determining by the continued random determination whether to display the specific symbol 501 (“SEVEN(7)”) as the predetermined symbol 501 on the reel device M1. The plurality of bonus types (3 of a kind combination, 4 of a kind combination, or 5 of a kind combination of “SEVEN(7)”) each may be associated with the number of specific symbols 501 (3 of a kind combination, 4 of a kind combination, or 5 of a kind combination) and the reel device M1 may display the same number of specific symbols 501 (“SEVEN(7)”) as the number (e.g., 3) associated with the set selected bonus type (e.g. 3 of a kind combination of “SEVEN(7)”) in the step (D).

With the above structure, the specific symbol 501 (“SEVEN(7)”) serving as the trigger for running of the bonus game is displayed in the step (D) during the bonus game. This facilitates the player to grasp the timing of transition from the normal game to the bonus game. The above structure also enables a structure in which, during the bonus game, the number of specific symbols 501 (“SEVEN(7)”) displayed in the step (D) gradually increases according to the results of the payout upgrading random determination. This allows the player to grasp changes in the selected bonus type and the amount of second payout step by step to a higher rank.

The above described first aspect may be adapted so that a plurality of paylines P10 are arranged in a display window 150 for symbols 501 (display area) of the reel device M1, and the plurality of paylines P10 include a predetermined number of (3 in the present embodiment) paylines P10a to P10c aligned in a vertical direction. Further, the step (C) may be executed when a specific symbol 501 (“SEVEN(7)”) is displayed in a position corresponding to at least one of the plurality of paylines P10, and that the step (C) may be a process of determining by the continued random determination whether to display the specific symbol 501 (“SEVEN(7)”) as the predetermined symbol 501 on the reel device M1. Further, in the step (D), the specific symbol 501 (“SEVEN(7)”) may be displayed in a position corresponding to a payline P10 out of the at least three paylines P10a to P10c other than the uppermost or lowermost paylines P10a and P10c, i.e., a payline P10b, and no specific symbol 501 (“SEVEN(7)”) may be displayed in positions corresponding to the uppermost or lowermost paylines P10a and P10c.

With the above structure, even when the specific symbol 501 (“SEVEN(7)”) serving as a trigger for a bonus game is displayed in any position corresponding to the lowermost payline P10c or an uppermost payline P10a out of the at least three paylines P10, the specific symbol 501 (“SEVEN(7)”) in the step (D) is displayed in a position corresponding to a payline P10 out of the three paylines P10 other than the uppermost payline or the lowermost paylines (i.e., payline P10b nearby the middle). This way the specific symbol 501 (“SEVEN(7)”) is displayed with a favorable visibility in the bonus game.

The plurality of different types of bonus (3 of a kind combination, 4 of a kind combination, or 5 of a kind combination of “SEVEN(7)”) may be associated with different modes of effects (effect images of flame in different colors, in the present embodiment), respectively. Further, the main CPU 71 executes the step of (K) providing an effect (displaying of an effect image of a flame) associated with the set selected bonus type (i.e., associated color), prior to the step (D).

The above structure enables an indication effect for the amount of the second payout before the predetermined symbol 501 (“SEVEN(7)”) is displayed or the second payout is awarded.

The above described slot machines 10 is a type of gaming machine. The present embodiment deals with a case where the slot machine 10 is an example of the gaming machine; however, the present invention is not limited to this, and is applicable to any given gaming machine configured to independently run any type of normal game and a bonus game (feature game).

The normal game in the present embodiment is run by the slot machines 10, in the present embodiment. The normal game is a slot game where a plurality of symbols 501 are rearranged. Note that the normal game is not limited to slot game: The normal game may be any type as long as it is independently runnable at a gaming machine such as a slot machine 10.

The rearrangement of the symbols 501 in the slot game is conducted on the reel unit M1 (display device). The slot game includes processes of: running a normal game on condition that a gaming value is bet, in which normal game the symbols 501 are rearranged in the reel device M1, and a first payout is awarded according to the symbols 501 rearranged; and when the symbols 501 are rearranged to meet a predetermined condition (rearrangement of 3 of a kind combination of “SEVEN(7)” in the present embodiment), running a bonus game where the symbols 501 are rearranged, and a second payout is awarded according to the symbols 501 rearranged (i.e., the number of “SEVEN(7)” symbols).

The type and the number of the symbols 501 is not limited as long as they are rearranged on the reel unit M1.

A coin, a bill, or electrically valuable information corresponding to these is used as a gaming value. Note that the gaming value in the present invention is not particularly limited. Examples of the gaming value include game media such as medals, tokens, cyber money, tickets, and the like. A ticket is not particularly limited, and a later-mentioned barcoded ticket may be adopted for example.

The bonus game has a same meaning as a feature game. In the present embodiment, the bonus game is a free game requiring betting of no gaming value. However, the bonus game is not particularly limited and may be any type of game, provided that the bonus game is more advantageous than the normal game for a player. Another bonus game may be adopted in combination, provided that a player is given more advantageous playing conditions than the normal game. For example, the bonus game may be a game that provides a player with a chance of winning more gaming values than the normal game or a game that provides a player with a higher chance of winning gaming values than the normal game. Alternatively, the bonus game may be a game that consumes fewer amounts of gaming values than the normal game. In the bonus game, these games may be provided alone or in combination.

The expression rearrange in this specification means dismissing an arrangement of symbols 501, and arranging symbols 501 once again. Arrangement means a state where the symbols 501 can be visibly confirmed by a player.

The phrase awarding of the first payout according to the symbols 501 displayed means to award a first payout (normal payout) corresponding to a rearranged winning combination. The phrase awarding of the second payout according to the predetermined symbol 501 displayed means to award a second payout based on the timing at which the predetermined symbol 501 is stopped or based on the number of the predetermined symbols 501. Furthermore, the term winning combination indicates that a winning is established.

(Functional Flow of Gaming System 300 Having Slot Machine 10)

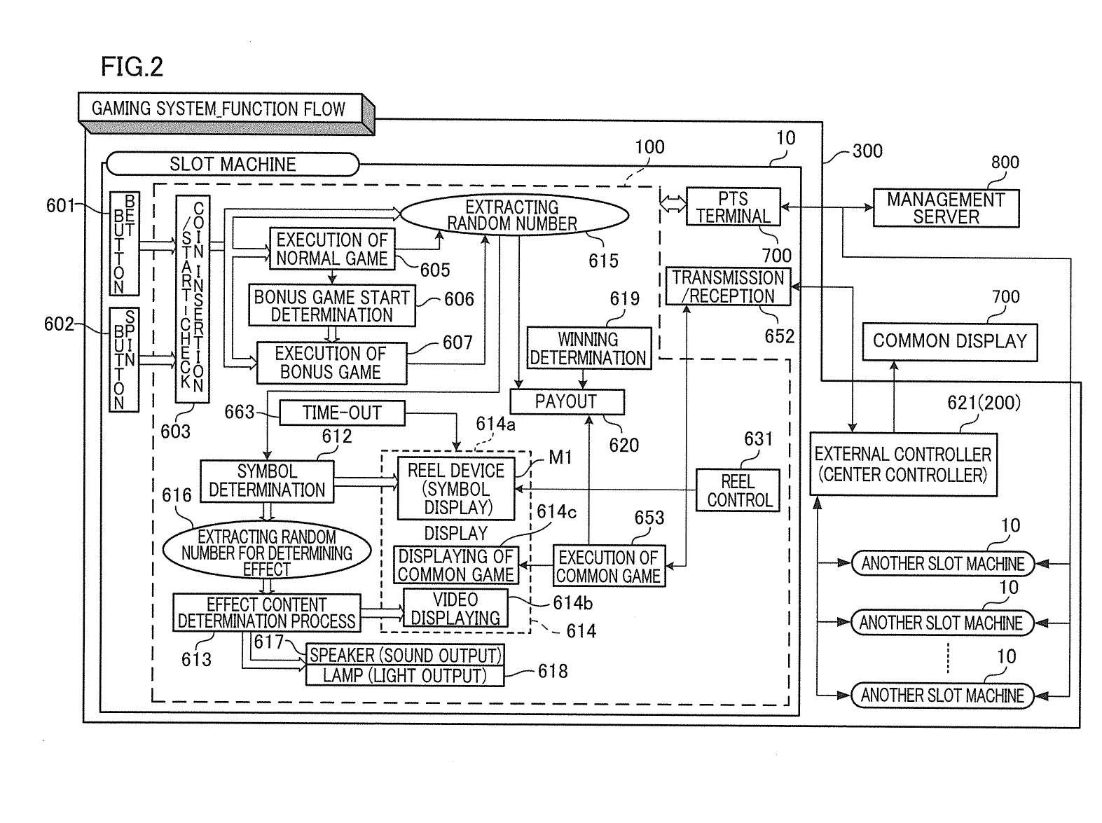

The following describes a gaming system 300 having a slot machine with the above described structure, with reference to FIG. 2. The gaming system 300 has slot machines 10 and an external controller 621 (center controller 200) connected to the slot machines 10 so as to allow data communications therebetween. The external controller 621 is connected to the slot machines 10 installed in the hall so that data communications is possible therebetween.

The slot machines 10 each include a bet button 601, a spin button 602, a display 614, and a game controller 100 which controls these units. Note that the bet button 601 and the spin button 602 each are a kind of an input device. Further, the slot machine 10 includes a transceiver unit 652 which enables data communications with the external controller 621.

The bet button 601 has a function of accepting a bet amount through a player's operation. The spin button 602 has a function of accepting a start of a game such as normal game through a player's operation, that is, a start operation. The display 614 has a function of displaying still-image information and moving-image information. Examples of the still-image information are various types of symbols 501, numeral values, and signs. Examples of the moving-image information include effect video. The display 614 has a symbol display region 614a, an image display region 614b, and a common game display region 614c.

The symbol display region 614a includes the reel unit M1 and displays the symbols 501 shown in FIG. 1. The image display region 614b displays various types of effect image information to be displayed during a game, in the form of a moving image or a still image. The common game display region 614c is a region where a common game such as a jackpot game is displayed.

The game controller 100 includes: a coin insertion/start-check unit 603; a normal game running unit 605; a bonus game start determining unit 606; a bonus game running unit 607; a random number sampling unit 615; a symbol determining unit 612; an effect-use random number sampling unit 616; an effect determining unit 613; a speaker unit 617; a lamp unit 618; a winning determining unit 619; and a payout unit 620.

The normal game running unit 605 has a function of running a normal game on condition that the bet button unit 601 has been operated. The bonus game start determining unit 606 determines whether to run a bonus game, based on a combination of rearranged symbols 501 resulted from the normal game. In other words, the bonus game start determining unit 606 has functions of: (i) determining that the player is entitled to a bonus game when one or more trigger symbols rearranged satisfy a predetermined condition (3 of a kind combination or a higher combination of “SEVEN(7)”) and (b) activating the bonus game running unit 607 so as to run a bonus game from the subsequent unit game.

Note that a unit game of the normal game includes a series of operations executed within a period between a start of receiving a bet and a point where a winning may be resulted. For example, bet reception, rearrangement of symbols 501 having been stopped, and a payout process to award a payout are executed once each within a single unit game of the normal game. Note that a unit game in a normal game is referred to as a unit normal game. Further, the unit game of the bonus game is a series of operations including execution of the continued random determination, and repetitively executing the displaying process of a predetermined symbol and the second payout process the same number of times as the number of times the continued random determination is executed. Note that a unit game in a bonus game is referred to as a unit bonus game.

The bonus game running unit 607 has a function of running the bonus game (free game) in response to an operation on the spin button 602. In the bonus game, rearrangement of the predetermined symbol 501 (“SEVEN(7)”) and payout of the second payout based on the rearrangement are repeated as long as the continued Random Determination results in a win.

The symbol determining unit 612 has functions of: determining symbols 501 to be rearranged based on a random number given from the random number sampling unit 615; rearranging the determined symbols 501 in the symbol display region 614a of the display 614; outputting information on rearrangement of the rearranged symbols 501 to the winning determining unit 619; and outputting an effect specifying signal to the effect-use random number sampling unit 616, based on the rearrangement of the symbols 501.

The effect-use random number sampling unit 616 has functions of: when receiving the effect instruction signal from the symbol determining unit 612, extracting an effect-use random number; and outputting the effect-use random number to the effect determining unit 613. The effect determining unit 613 has functions of: determining an effect by using the effect-use random number; outputting image information on the determined effect in the image display region 614b of the display 614; outputting audio and illumination information on the determined effect to the speaker unit 617 and the lamp unit 618, respectively.

The winning determining unit 619 has functions of: determining whether a winning is achieved when information on symbols 501 rearranged and displayed on the display 614 is given; calculating an amount of payout based on a winning combination formed when it is determined that a winning has been achieved; outputting to the payout unit 620 a payout signal which is based on the payout amount. The payout unit 620 has a function of paying out a gaming value to a player in the form of a coin, a medal, a credit, or the like. Further, the payout unit 620 has a function of adding credit data to credit data stored on an IC card (not shown) inserted into a later-described PTS terminal 700, the credit data to be added corresponding to the credit to be paid out.

In addition to the above, the game controller 100 includes an unillustrated storage unit which stores various bet amount data. The storage unit is a storage device which stores data in a rewritable manner, such as a hard disk and a memory.

Further, the game controller 100 has a common game running unit 653. The common game running unit 653 has functions of: outputting bet amount information to the external controller 621 for each unit normal game, the bet amount information being based on a bet amount placed as a bet on a normal game; running a common game in response to a game start command from the external controller 621; and accepting a bet input through the bet button unit 601 when the bet input corresponds to common game bet amount data indicating a bet amount bettable on the common game.

Further, the game controller 100 is connected to the PTS terminal 700. The PTS terminal 700 is a unit in which an LCD (not shown), a microphone (not shown), a human body detection camera (not shown), etc. are integrated, and has, for example, a function of executing an effect for a game by mutual communications with the game controller 100. In particular, the PTS terminal 700 has a card slot 706 to which an IC card (not shown) can be inserted. Thus allows a player to use a credit stored on an IC card (not shown) at a slot machine 10, by inserting the IC card into the card slot 706.

Further, when receiving credit data from the PTS terminal 700, the game controller 100 updates a credit display on the display 614. Further, when a cash out occurs, the game controller 100 outputs cash-out credit data to the PTS terminal 700.

The PTS terminal 700 of each of the plurality of slot machines 10 constituting the gaming system 300 is connected in communication with a management server 800, which performs central management of image downloading, IC cards, and credits.

Further, the slot machine 10 includes a reel control unit 631 configured to control rotation of the reel M3 of the reel device M1.

(Mechanical Structure of Slot Machine)

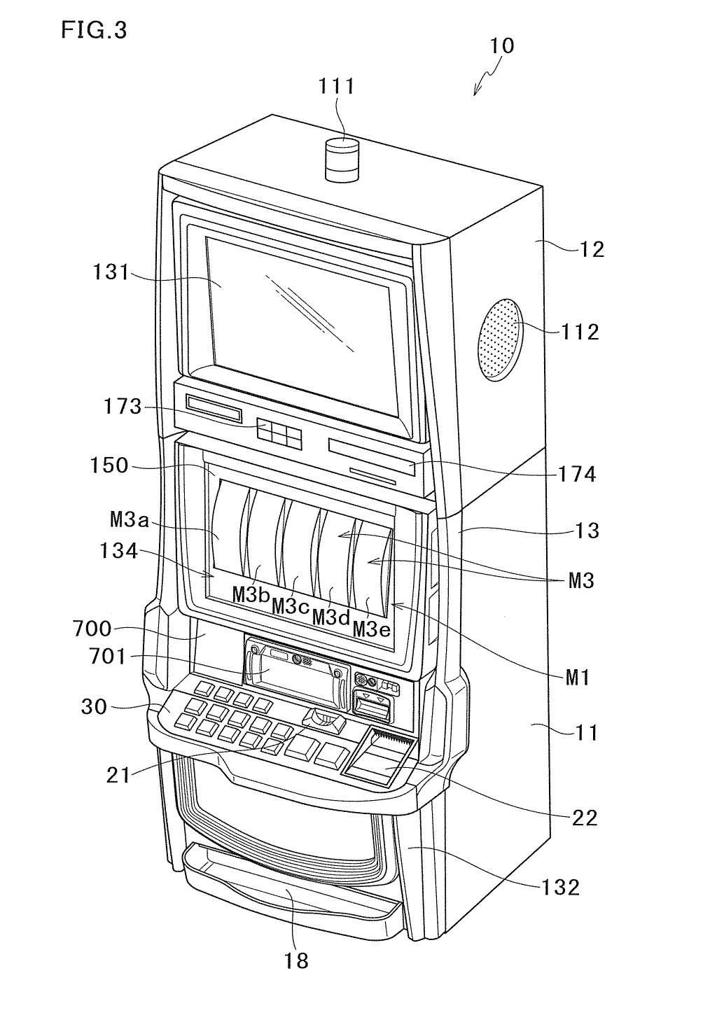

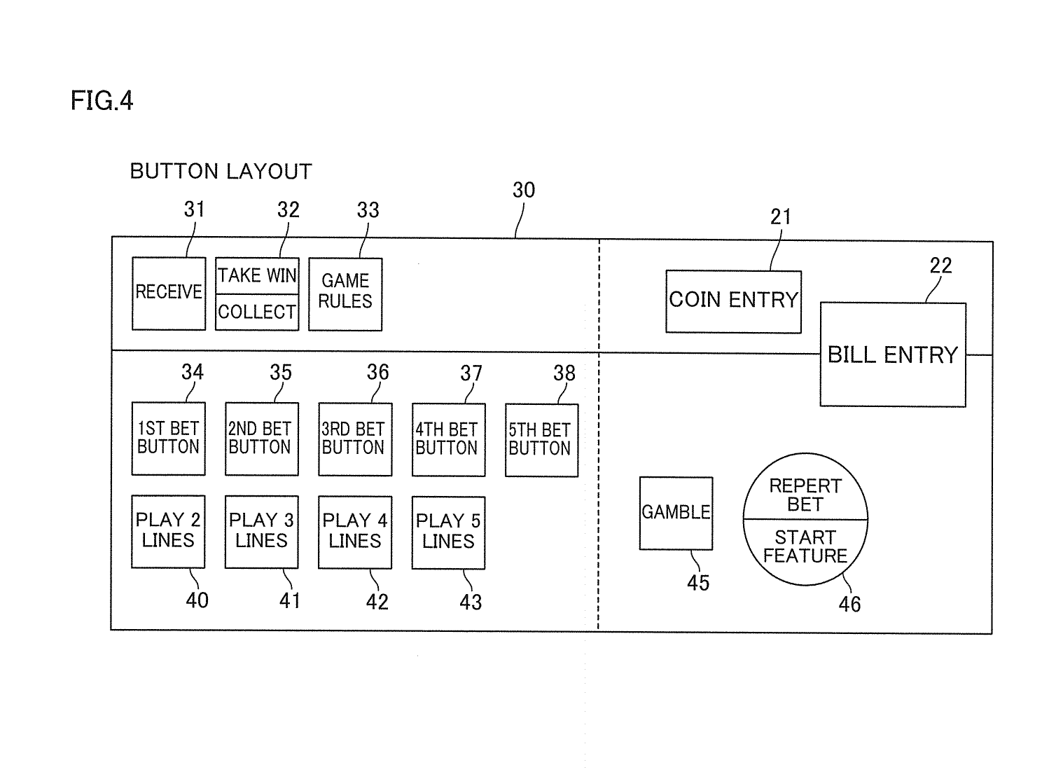

The following describes an entire structure of a slot machine 10 with reference to FIG. 3 and FIG. 4.

A coin, a bill, or electrically valuable information corresponding to these is used as game media in the slot machines 10. In particular, the present embodiment uses credit-related data stored in the IC card (not-shown), such as cash data.

The slot machine 10 has a cabinet 11, a top box 12 provided above the cabinet 11, and a main door 13 provided on the front face of the cabinet 11.

The main door 13 is provided with a reel unit M1. On the front surface of the reel unit M1 is provided a reel cover 134. The reel cover 134 has a transparent liquid crystal panel at the central portion. Each of the reel cover 134 and the transparent panel may be provided with a touch panel. In such a case, a player is able to input instructions through the touch panel. Input signals are sent from the touch panel to the main CPU 71 (FIG. 5). The reel cover 134 has a display window 150 at the central portion. The display window 150 allows 15 symbols 501 (FIG. 1) forming a matrix of three rows and five columns to be viewable from the outside. Three symbols 501 in each column are a part of symbol group aligned on the outer circumferential surface of a reel M3. Each reel M3 enables rotation of the displayed symbols 501 in vertical directions and then stopping the rotation for rearrangement, by moving the entire three symbols 501 upward or downward.

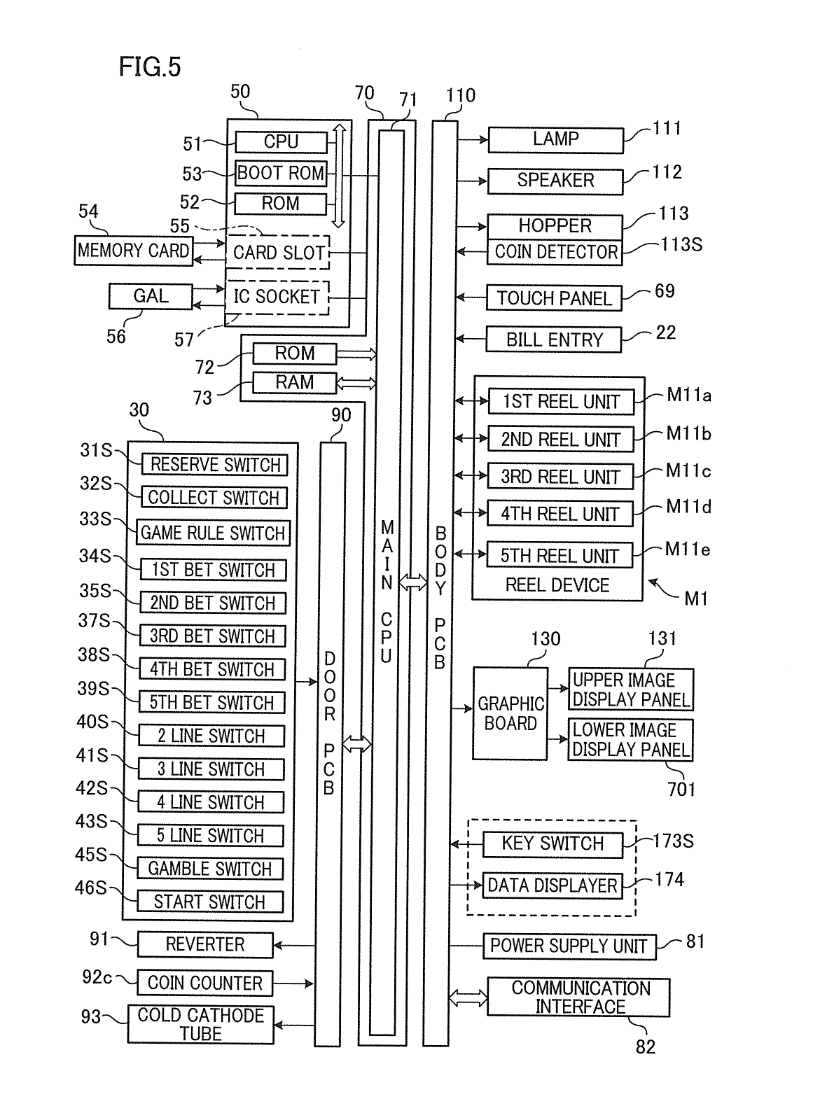

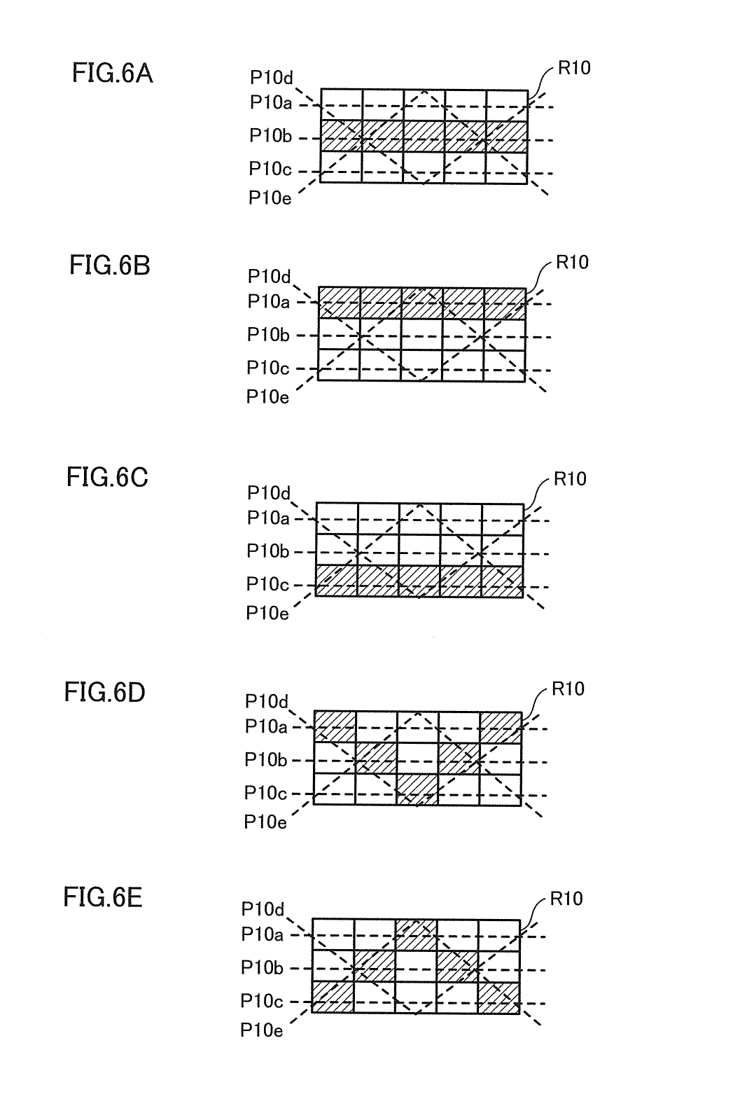

As shown in FIG. 6A to FIG. 6E, five paylines P10 are arranged on the display window 150 of the slot machine 10. Of the five paylines P10, three paylines are aligned in the vertical direction. It is possible to have four or more paylines aligned in the vertical direction. It should be noted that the payline arranged uppermost out of the three paylines P10 is a first payline P10a, and the one in the middle is a second payline P10b, and the one arranged lowermost is a third payline P10c. Further, on the display window 150 is arranged a V-shaped payline P10 (P10d) and a counter-V-shaped payline P10 (P10e).

It should be noted that the present embodiment deals with a case where the slot machine 10 employs the reel device M1 in the form of mechanical reels; however, the slot machine 10 of the present invention may adopt video reels displaying pseudo reels.

Below the reel unit M1 is provided a control panel 30. In addition to various buttons, the control panel 30 has a coin entry 21 which accepts coins into the cabinet 11, and a bill entry 22.

Specifically, as shown in FIG. 4, the control panel 30 has a reserve button 31, a collect button 32, and a game rule button 33 to an upper left region thereof. The control panel 30 further includes a first bet button 34, a second bet button 35, a third bet button 36, a fourth bet button 37, and a fifth bet button 38 to a middle left region thereof. Moreover, the control panel 30 further includes a play-2-line button 40, a play-3-line button 41, a play-4-line button 42, a play-5-line button 43 provided to a lower left region thereof.

Further, the control panel 30 has the coin entry 21 and the bill entry 22 in an upper right region thereof, and a gamble button 45 and a spin button 46 in a lower right region thereof.

The reserve button 31 is an operation button used when a player leaves the machine or when the player requests a staff person of the gaming facility to exchange money. The collect button 32 is so-called a balance adjustment button, which executes addition of the credit data related to credits obtained in various games to the credit data stored in the IC card inserted into the PTS terminal 700 (FIG. 2). The game rule button 33 is pressed when, for example, it is unclear how to play a game. As the game rule button 33 is pressed, various help information is displayed on a later-described upper image display panel 131.

The first bet button 34, the second bet button 35, the third bet button 36, the fourth bet button 37, and the fifth bet button 38 places a bet of game media upon being pressed down by a player. For each of the bet buttons 34 to 38, a bet amount to be placed on an active payline is associated, and the amount of game media bet varies based on operation of the bet button 34 to 38 by the player. The bet amount to be placed on an active payline, in association with the bet buttons 34 to 38 is detailed later in the section of (Bet Button).

The play-2-line button 40, when pressed, activates paylines. Pressing this button increases the number of paylines activated by 2. The play-3-line button 41, when pressed, activates paylines. Pressing this button increases the number of paylines activated by 3. The play-4-line button 42, when pressed, activates paylines. Pressing this button increases the number of paylines activated by 4. The play-5-line button 43, when pressed, activates paylines. Pressing this button increases the number of paylines activated by 5.

The gamble button 45 is used to play a gamble game after the end of a bonus game, for example. The gamble game is played using obtained credits.

The spin button (start button) 46 is used to start the scroll of the symbols 501. This spin button 46 also functions as a button for starting a bonus game and for adding a payout awarded in a bonus game to the credits. The coin entry 21 is used for receiving coins (game media) into the cabinet 11. The bill entry 22 validate bills and receives genuine bills into the cabinet 11.

As shown in FIG. 3, below the reel unit M1 in the mid portion of the front surface of the main door 13, a lower image display panel 701 is arranged. The lower image display panel 701 is, for example, a liquid crystal display device and is configured to perform displaying of an effect image and display based on game related information. Further, on a lower front face of the main door 13, that is, below the control panel 30 is a coin receiving port 18 for accepting coins (game media), and a belly glass 132 with a character related to the slot machine 10 shown thereon.

On the front surface of the top box 12 is provided an upper image display panel 131. The upper image display panel 131 is made up of a liquid crystal panel and constitutes a display. The upper image display panel 131 displays image concerning effects, an introduction to games, images for explaining rules of games, or the like. The top box 12 is provided with a speaker 112 and a lamp 111. In the slot machine 10, effects are provided in the forms of image displaying, sound output, and illumination.

Below the upper image display panel 131 is provided a data displayer 174 and a keypad 173. The data displayer 174 is constituted by a fluorescent display, an LED, and the like. The data displayer 174 displays membership data read our from the IC card inserted into the PTS terminal 700 (FIG. 2), and data input by the player through the keypad 173, for example. The keypad 173 is provided for data input.

(Electrical Structure of Slot Machine)

The following describes a circuitry structure of the slot machine 10, with reference to FIG. 5.

The gaming board 50 has a CPU 51, a ROM 52, a boot ROM 53 which are connected via an internal bus, a card slot 55 corresponding to the memory card 54, and an IC socket 57 corresponding to a GAL (Generic Array Logic) 56.

The memory card 54 includes a nonvolatile memory, and stores a game program and a game system program. The game program includes a program related to game progression and a program for producing effects by images and sounds. The game program includes a symbol determining program. The symbol determining program is a program for determining symbols to be rearranged.

Further, the game program includes: a normal game symbol table data showing a symbol random determination table T1 (FIG. 7) showing each symbol of each symbol array of the display blocks in association with a code number and a random number; and odds data (payout table) showing the number and types of symbols to be rearranged on a payline in association with an amount of payout; and the like.

In addition to the above, the card slot 55 is arranged to be receivable the memory card 54, and is connected to a motherboard 70 via an IDE bus. Thus, it is possible to remove a memory card 54 from the card slot 53S, write another game program onto the memory card 54, and insert the memory card 54 back into the card slot 53S to change the type or content of a game to be run at the slot machine 10.

The GAL 56 is a type of PLD (Programmable Logic Device) having a fixed OR array structure. The GAL 56 is provided with a plurality of input ports and output ports, and a predetermined input into the input port causes output of the corresponding data from the output port.

Further, the IC socket 57 is configured so that the GAL 56 can be inserted thereinto and removed therefrom, and is connected to the motherboard 70 by a PCI bus. The contents and the nature of the game to be played on the slot machine 10 can be changed by replacing the memory card 54 with another memory card 54 having another program written therein or by rewriting the program written into the memory card 54 as another program.

The CPU 51, the ROM 52 and the boot ROM 53 mutually connected by the internal bus are connected to the motherboard 70 by a PCI bus. The PCI bus enables a signal transmission between the motherboard 70 and the gaming board 50, and power supply from the motherboard 70 to the gaming board 50.

The ROM 52 stores an authentication program. The boot ROM 53 stores a pre-authentication program, a program (boot code) to be used by the CPU 51 for activating the preliminary authentication program, and the like.

The authentication program is a program (falsification check program) for authenticating the game program and the game system program. The pre-authentication program is a program for authenticating the aforementioned preliminary authentication program. The authentication program and the preliminary authentication program are written along a procedure (authentication procedure) for proving that the program to be the subject has not been falsified.

The motherboard 70 is constituted by a motherboard for market use (printed circuit board with fundamental parts of a personal computer built thereon), and includes a main CPU 71, a ROM (Read Only Memory) 72, a RAM (Random Access Memory) 73, and a communication interface 82. The motherboard 70 is equivalent to the game controller 100 of the present embodiment.

The ROM 72 includes a memory device such as a flash memory, and stores a program such as BIOS (Basic Input/Output System) to be executed by the main CPU 71, and permanent data. When the BIOS is executed by the main CPU 71, processing for initializing predetermined peripheral devices is conducted; Further, through the gaming board 50, processing of loading the game program and the game system program stored in the memory card 54 is started. It should be noted that, in the present invention, the ROM 72 may be a one which is rewritable or a one that cannot be rewritten.

The RAM 73 stores data and programs, such as a symbol determining program, which are used in operation of the main CPU 71. For example, when the processing of loading the aforementioned game program, game system program or authentication program is conducted, the RAM 73 can store the program. The RAM 73 is provided with working areas used for operations in execution of these programs. Examples of the areas include: an area that stores counter configured to manage the number of games, the number of BETs, the number of payouts, the number of credits and the like; and an area that stores symbols (code numbers) randomly determined.

The communication interface 82 is for communicating with an external controller 621 such as a server, through a communication line 301. Further, the motherboard 70 is connected with a later-described door PCB (Printed Circuit Board) 90 and a body PCB 110 by respective USBs. The motherboard 70 is also connected with a power supply unit 81. The motherboard 70 is also connected with PTS terminal 700 via a USB.

When power is supplied from the power supply unit 81 to the motherboard 70, the main CPU 71 of the motherboard 70 is booted, and power is supplied to the gaming board 50 via the PCI bus and the CPU 51 is booted.

The door PCB 90 and the main body PCB 110 are connected to an input device such as a switch and a sensor, and peripheral devices whose operations are controlled by the main CPU 71.

The door PCB 90 is connected to the control panel 30, a reverter 91, a coin counter 92C and a cold cathode tube 93.

The control panel 30 includes, in association with the above-mentioned buttons; a reserve switch 31S, a collect switch 32S, a game rule switch 33S, a first bet switch 34S, a second bet switch 35S, a third bet switch 37S, a fourth bet switch 38S, a fifth bet switch 39S, a play-2-line switch 40S, a play-3-line switch 41S, a play-4-line switch 42S, a play-5-line switch 43S, a gamble switch 45S, and a start switch 46S. Each switch detects that the corresponding button has been pressed by a player, and outputs a signal to the main CPU 71.

Inside the coin entry 21 are a reverter 91 and a coin counter 92C. The reverter 91 checks the genuineness of each coin inserted into the coin entry 21, and ejects non-genuine coins through a coin outlet. The coin counter 92C detects the received genuine coins and counts the number thereof.

The reverter 91 operates based on a control signal outputted from the main CPU 71, and distributes valid coins validated by the coin counter 92C into a hopper 113 or a cash box (not illustrated). That is, coins are distributed into the hopper 113 when the hopper 113 is not filled with coins, while coins are distributed into the cash box when the hopper 113 is filled with coins.

The cold cathode tube 93 functions as a backlight installed on the rear face side of the upper image display panel 131, and lights up based on a control signal output from the main CPU 71.

The main body PCB 110 is connected to the lamp 111, the speaker 112, the hopper 113, the coin detector 113S, the bill entry 22, the graphic board 130, the key switch 173S, and the data displayer 174.

The lamp 111 is turned on based on a control signal output from the main CPU 71. The speaker 112 outputs sounds such as BGM, based on a control signal outputted from the main CPU 71.

The hopper 113 operates based on a control signal outputted from the main CPU 71, and pays out coins of the specified number of payouts from the coin outlet to the coin tray. The coin detector 113S outputs a signal to the main CPU 71 upon detection of coins paid out by the hopper 113.

It should be noted that on the front surface of the reel device M1, a touch panel, a transparent liquid crystal panel for effects may be provided. The touch panel detects a place touched by the player's finger or the like, and outputs to the main CPU 71 a position signal corresponding to the detected place.

The bill entry 22 validate bills and receives genuine bills into the cabinet 11. The bills accepted into the cabinet 11 are converted into coins, and credits corresponding to the number of coins calculated are added as credits that the player has.

The graphic board 130 controls display of images conducted by the upper image display panel 131 and the lower image display panel 701, based on a control signal outputted from the main CPU 71. The graphic board 130 is provided with a VDP (Video Display Processor) generating image data, a video RAM temporarily storing the image data generated by the VDP, and the like. Image data used for generating image data by the VDP is included in a game program which has been read out from the memory card 54 and stored in the RAM 73.

The graphic board 130 is provided with a VDP (Video Display Processor) generating image data based on the control signal from the main CPU 71, a video RAM temporarily storing the image data generated by the VDP, and the like. Image data used for generating image data by the VDP is included in a game program which has been read out from the memory card 54 and stored in the RAM 73.

The key switch 173S is provided in the keypad 173, and outputs a predetermined signal to the main CPU 71 when the keypad 173 has been operated by the player.

The data displayer 174 displays data read by the card reader 172 and data inputted by the player through the keypad 173, based on a control signal outputted from the main CPU 71.

(Displaying of Symbols 501 in Position Corresponding to Payline P10)

The following describes displaying (rearranging) of symbols 501 in positions corresponding to a payline P10, with reference to FIG. 1, FIG. 6A to FIG. 6E. As hereinabove described, five paylines P10 (P10a to P10e) are arranged on the display window 150 of the slot machine 10. Of the five paylines P10, three paylines are aligned in the vertical direction. Of the three paylines P10, FIG. 6A shows the second payline P10b arranged in the middle and the positions for arranging symbols 501, corresponding to the second payline P10b. As hereinabove described, 15 symbols 501 are displayable in a matrix of 3 rows×5 columns, on the display window 150. In other words, symbol arrangement areas in a matrix of 3 rows×5 columns are set on the display windows 150. The matrix of symbol arrangement areas is hereinafter referred to as arrangement area matrix R10. Of the arrangement area matrix R10, the second line is the positions for arranging symbols 501, corresponding to the second payline P10b. For example, when a predetermined symbol 501 stops in the second line of the arrangement area matrix R10, that predetermined symbol 501 is regarded as to have stopped on the second payline P10b.

It should be noted that, as shown in FIG. 6B, the first payline P10a at the uppermost stage is associated with the first line of the arrangement area matrix R10. Further, as shown in FIG. 6C, the third payline P10c at the lowermost stage is associated with the third line of the arrangement area matrix R10.

Further, as shown in FIG. 6D, the arrangement area matrix R10 has a V-shape arrangement position line for symbols 501 which is associated with the fourth payline P10d in a V-shape. Further, as shown in FIG. 6E, the arrangement area matrix R10 has a counter V-shape arrangement position line for symbols 501 which is associated with the fifth payline P10e in a counter V-shape.

(Symbol Random Determination Table T1)

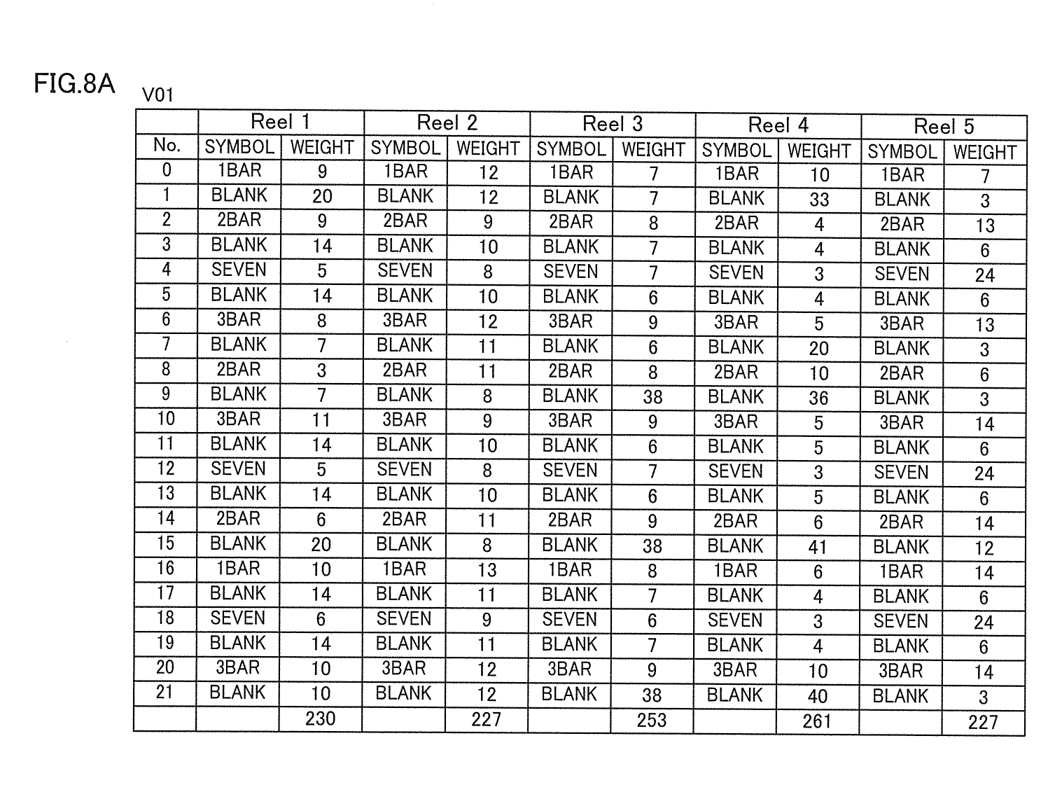

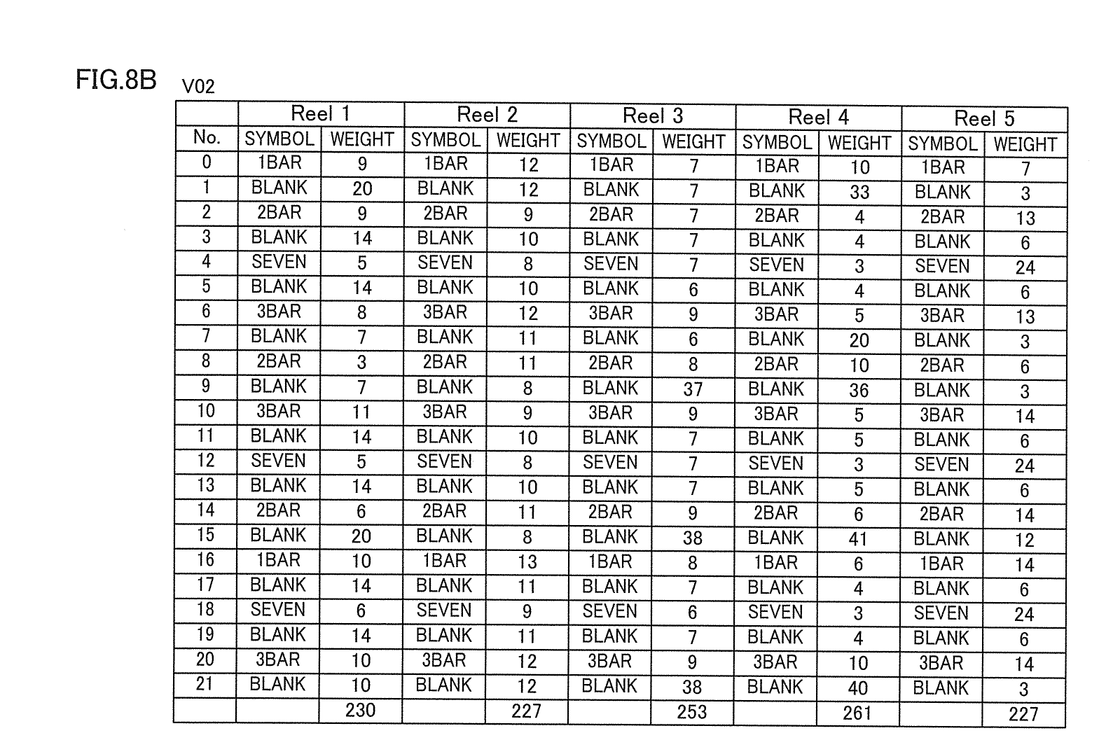

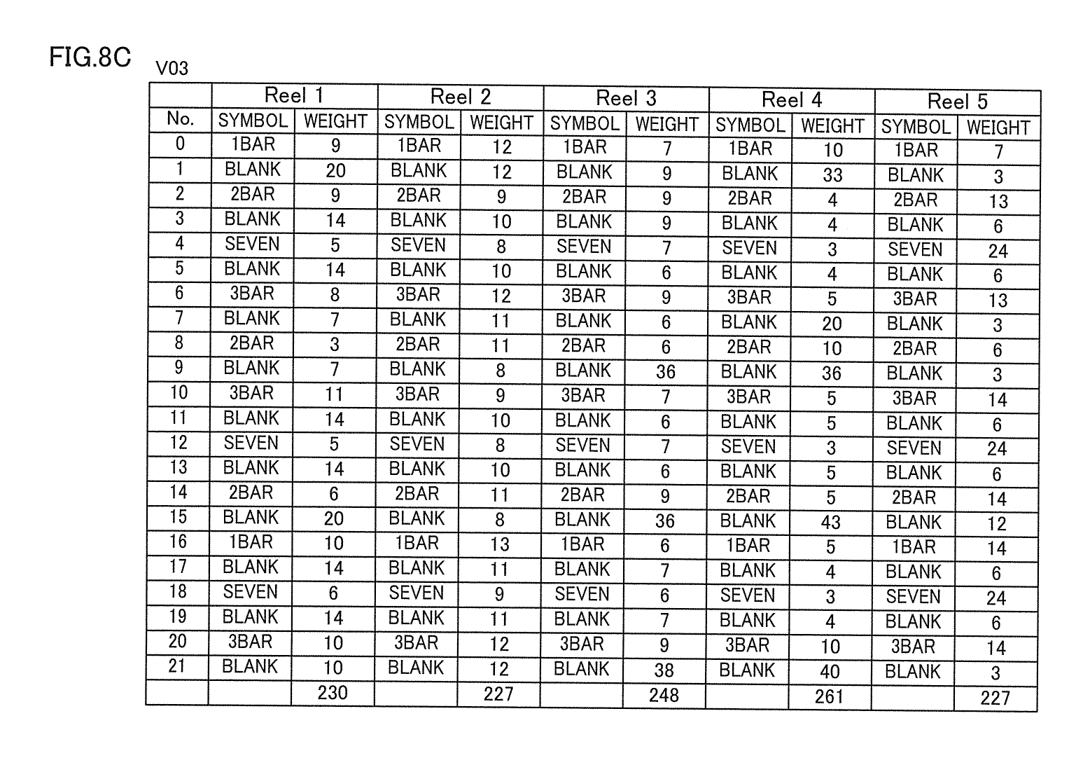

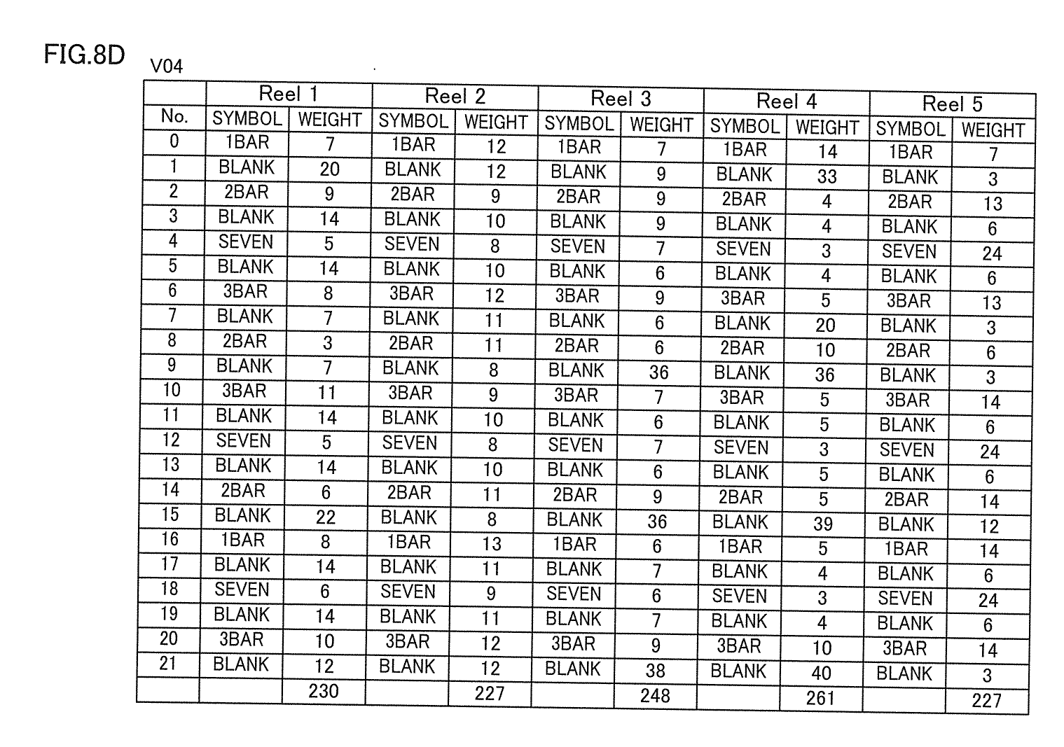

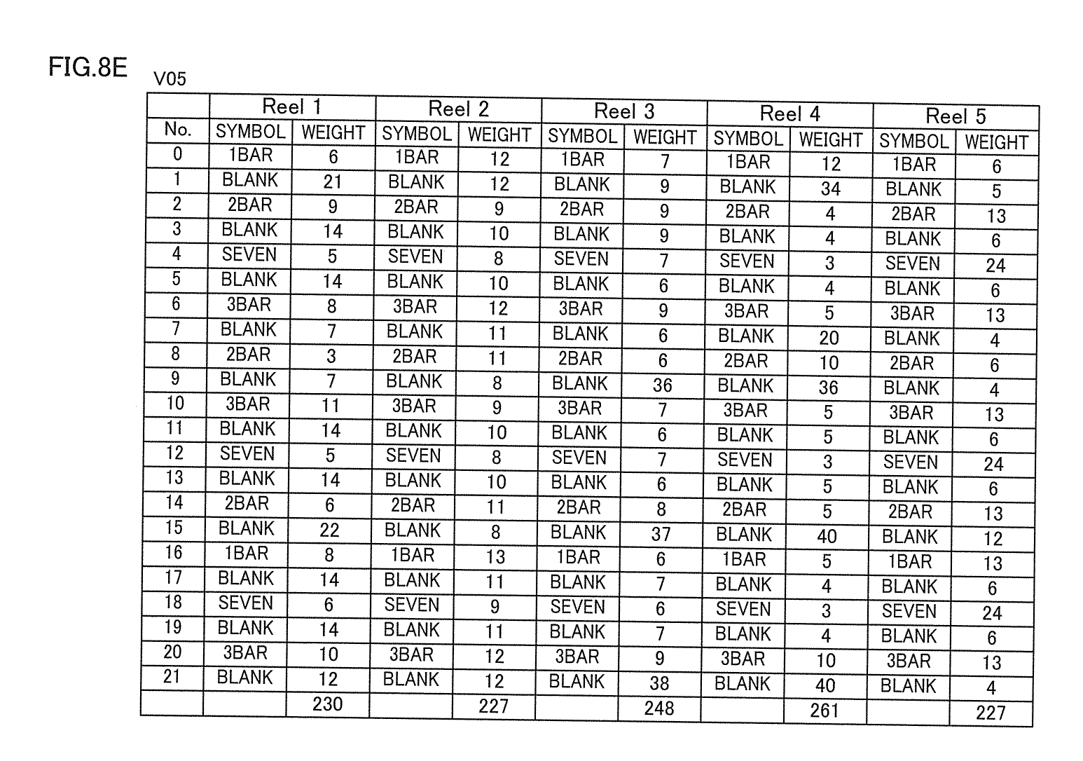

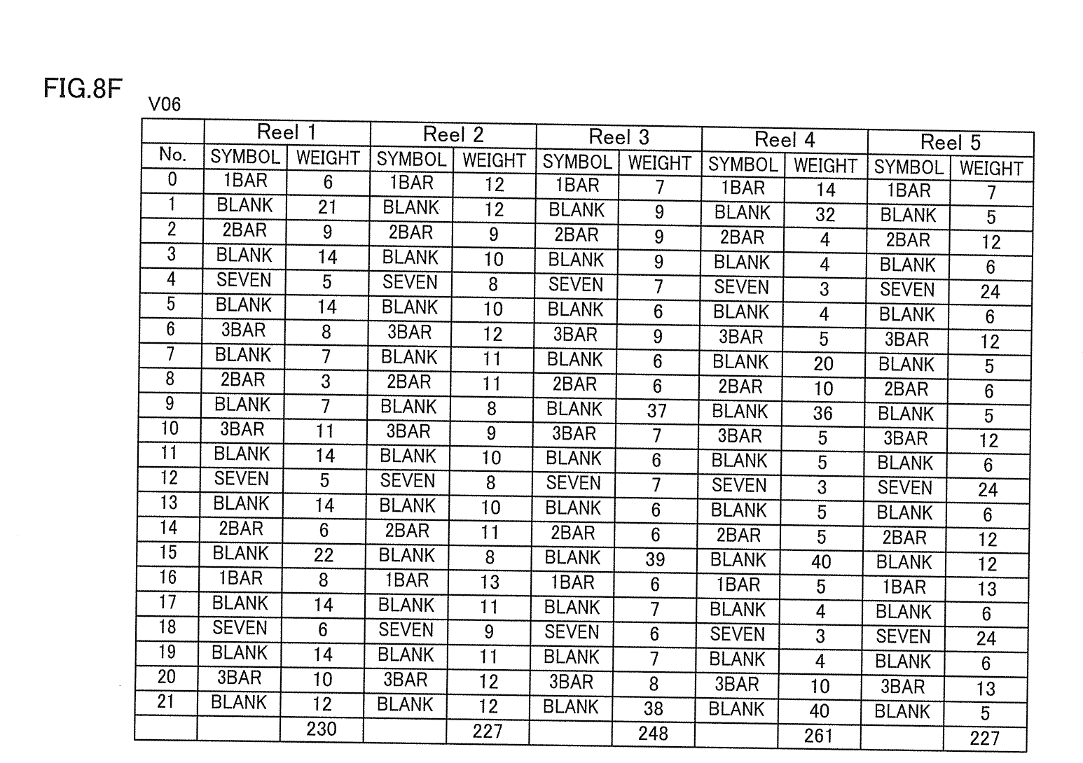

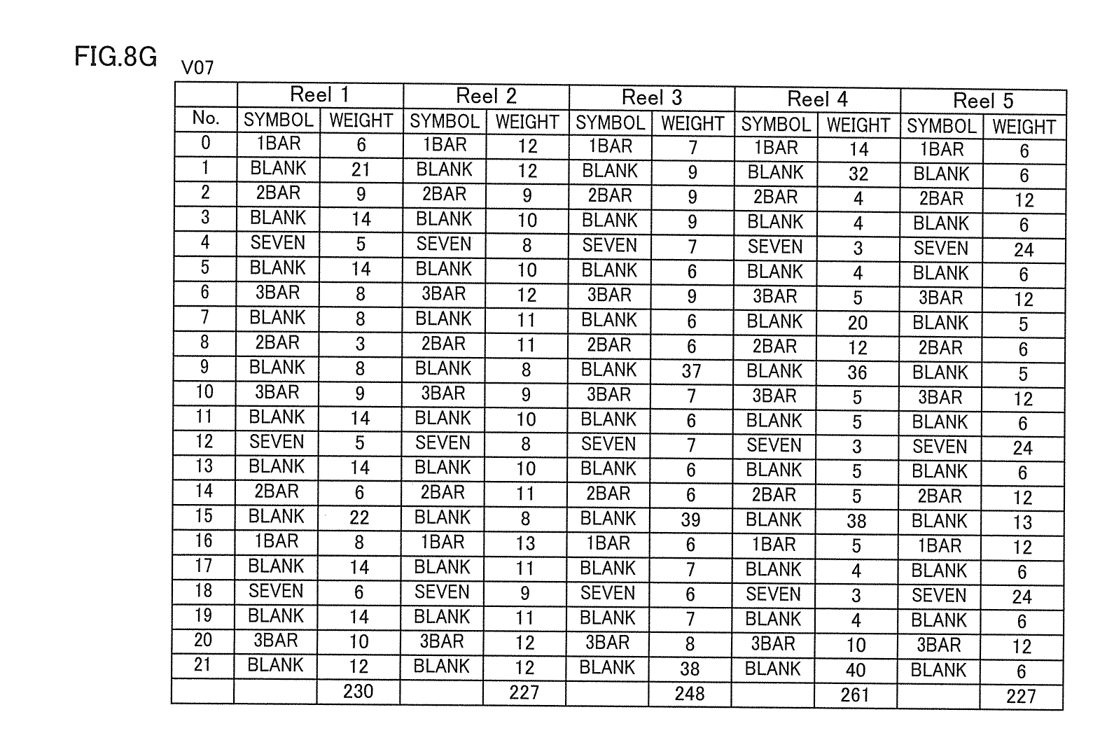

The symbol random determination table T1 is described below, with reference to FIG. 7, FIG. 8A, and FIG. 8G. The symbol random determination table T1 shown in FIG. 7 is a table used for determining symbols 501 in the symbol random determination (corresponding to first random determination) in the normal game. The symbols determined are rearranged (stop-displayed) in the normal game. In the symbol random determination table T1, the symbols 501 of each reel are associated with code numbers, respectively. Each code number of each reel M3 is associated with any of 22 number ranges which altogether cover 0 to a predetermined number. It should be noted that, in FIG. 7, the reel 1 corresponds to the first reel M3a, the reel 2 corresponds to the second reel M3b, the reel 3 corresponds to the third reel M3c, the reel 4 corresponds to the fourth reel M3d, and the reel 5 corresponds to the fifth reel M3e.

In the symbol random determination of the present embodiment, a random number is randomly sampled, and a symbol with a code number associated with a number range including the selected random number. For example, suppose that a random number randomly selected is included in a number range associated with code No. 4 of the first reel M3a. In this case, the symbol of “SEVEN(7)” associated with the code No. 4 is determined. The symbol of “SEVEN(7)” is therefore stop-displayed on the display window 150.

It should be noted that the broadness of the scope of each number range (i.e., how many numbers each range covers) may be the same or different. Differentiating the broadness of the scope of the number ranges results in various percentages of symbols 501 stop-displayed for each reel M3. FIG. 8A to FIG. 8G shows a case where the broadness of the scope of the number ranges are different, and the weights set for symbols 501 of the reels M3 are different. In FIG. 8A to FIG. 8G, the weights set for symbols 501 of the reels M3 are different; however, the present embodiment allows selectively setting any of the settings of FIG. 8A to FIG. 8G.

(Bet Button)

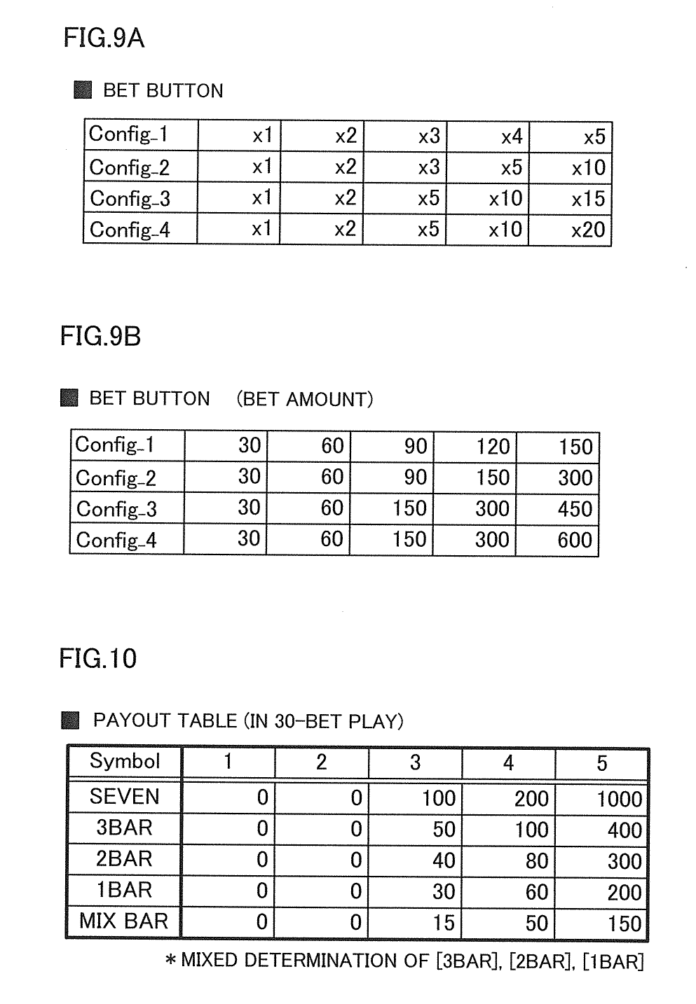

The following describes the bet buttons with reference to FIG. 9A and FIG. 9B. As described above, the slot machine 10 has five bet buttons (i.e., the first bet button 34, the second bet button 35, the third bet button 36, the fourth bet button 37, and the fifth bet button 38). In the normal game of the present embodiment, the minimum bet unit is 30 game media. Each row in FIG. 9A and FIG. 9B indicates selectable settings. An operator is able to selectively set any of the Config_1, Config_2, Config_3, Config_3, Config_4, and Config_5. The default setting in the present embodiment is Config_2.

Four columns on the right in FIG. 9A indicates odds for the minimum bet unit set for the first to fifth bet buttons. Specifically, the first column indicates a multiplying factor for the minimum bet unit set for the first bet button; the second column indicates a multiplying factor for the minimum bet unit set for the second bet button; the third column indicates a multiplying factor for the minimum bet unit set for the third bet button; the fourth column indicates a multiplying factor for the minimum bet unit set for the fourth bet button; and the fifth column indicates a multiplying factor for the minimum bet unit set for the fifth bet button.

Further, five columns on the right in FIG. 9B indicates the number of game media to be placed as a bet, which is set for each of the first to fifth bet buttons. Specifically, the first column indicates the setting of the number of bet game media to be bet, for the first bet button; the second column indicates the setting of the number of bet game media to be bet, for the second bet button; the third column indicates the setting of the number of bet game media to be bet, for the third bet button; the fourth column indicates the setting of the number of bet game media to be bet, for the fourth bet button; and the fifth column indicates the setting of the number of bet game media to be bet, for the fifth bet button.

For example, when Config_1 is set, the multiplying factor set for the minimum bet unit of the fifth bet button is ×5. Therefore, the amount of game media bet when the fifth bet button is pressed is: the minimum bet unit×5=150. It should be noted that in the present embodiment, a denomination setting range is 0.01 to 10 dollars, and the recommended denomination is 0.01 dollars.

(Payout Table)

The following describes a payout table used for the normal game and a feature game (bonus game), with reference to FIG. 10. FIG. 10 indicates a payout amount (the number of game media awarded), when 30 game media is bet in the normal game. For example, when 30 game media is bet, and when three “SEVEN(7)” symbols are stop-displayed in any of the first to fifth paylines in the normal game, a hundred game media are awarded (added to the credit). Two hundreds game media are awarded, when four “SEVEN(7)” symbols are stop-displayed on any of the first to fifth paylines P10a, P10b, P10c, P10d, and P10e. A thousand game media are awarded, when five “SEVEN(7)” symbols are stop-displayed on any of the first to fifth paylines. When 60 game media are bet, the number of game media awarded is a double the number indicated in FIG. 10. When 90 game media are bet, the number of game media awarded is a triple the number indicated in FIG. 10. When 120 game media are bet, the number of game media awarded is a quadruple the number indicated in FIG. 10. When 150 game media are bet, the number of game media awarded is a quintuple the number indicated in FIG. 10.

It should be noted that (Cherry) is a scatter symbol, and assessment for the symbols 501 other than the scatter symbol is done based on arrangement of them from the left to right. For (MIX BAR), assessment is done based on whether a (BAR) is stop-displayed on the payline P10 and (3BAR), (2BAR), and (1BAR) are not distinguished from one another (Mixed Assessment).

The bonus game on the other hand requires betting of no game media by the player. Therefore, the game media awarded are the amounts of payout as they are in FIG. 10. It is possible to change the number of game media awarded similarly to the normal game, based on the number of game media placed as a bet in a unit normal game triggering the execution of the bonus game. The bonus game may require the player to bet an amount of game media.

(Setting of Gaming Machine)

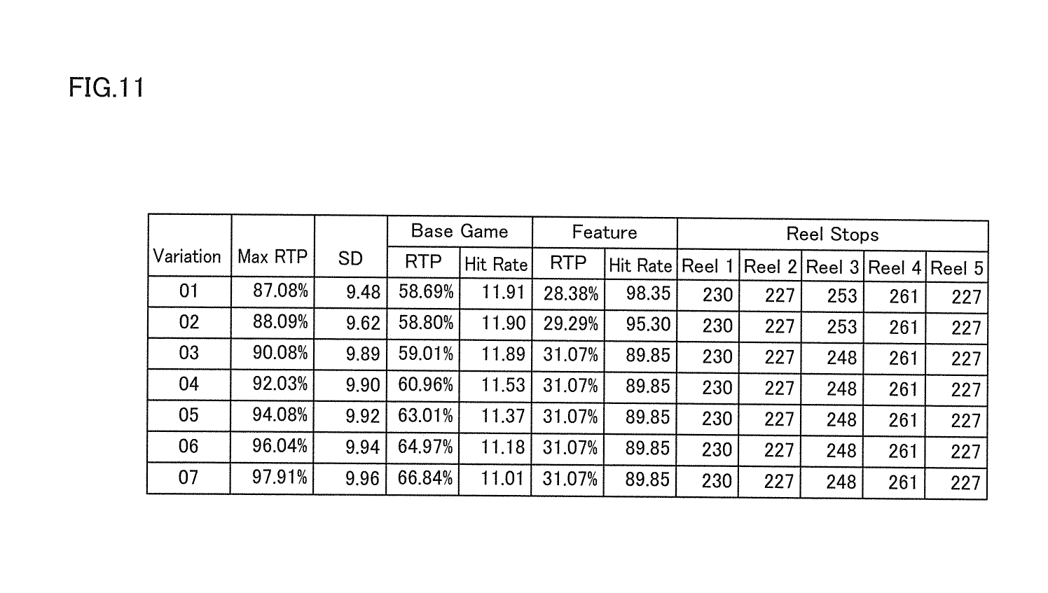

FIG. 11 shows an example of various settings of the slot machine 10. It should be noted that the settings shown in FIG. 11 are no more than an example, and are suitably modifiable.

(Normal Game)

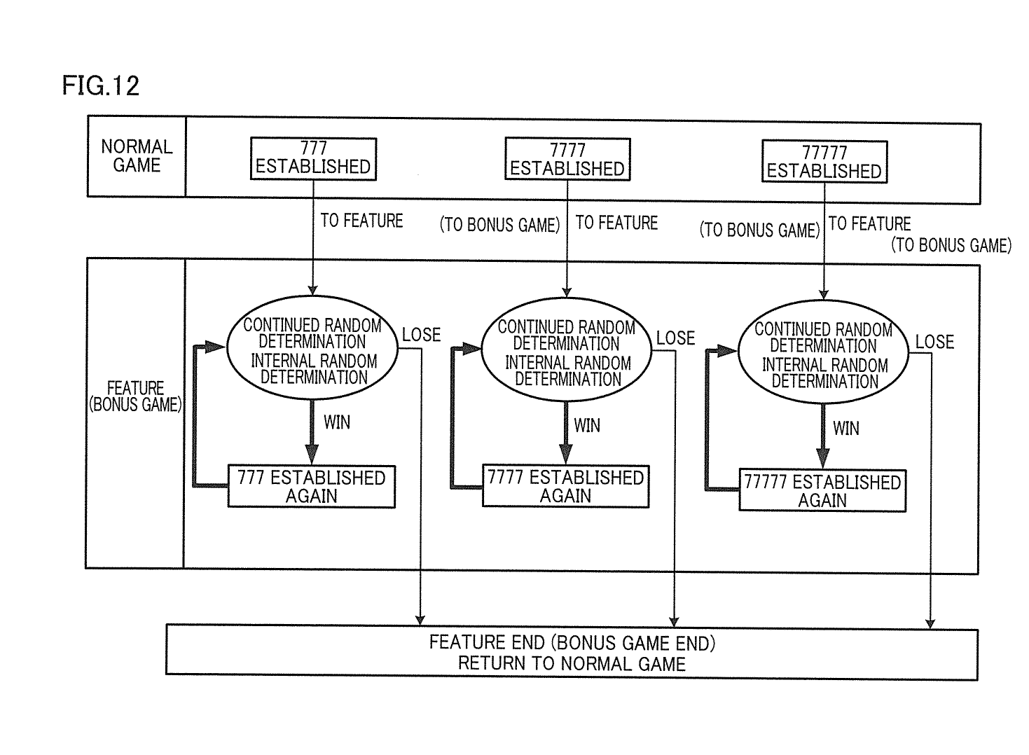

The following describes a normal game with reference to FIG. 12. In the present embodiment, the slot machine 10 runs the normal game, when the player has bet an amount of game media. In the normal game, the symbol random determination process, the displaying process, and the payout process are executed. In the symbol random determination process, a symbol random determination is executed for determining a plurality of symbols 501 to be displayed on the display window 150 of the reel device M1, based on the symbol random determination table T1. In the displaying process, the plurality of symbols 501 determined in the symbol random determination are displayed on the display window 150. It should be noted that the present embodiment deals with a case where a plurality of symbols 501 are determined and the symbols 501 determined are stop-displayed; however, it is possible to adopt a structure in which a single symbol 501 is determined and the symbol determined is displayed.

In the payout process, a payout is awarded based on the plurality of symbols 501 (i.e., symbols determined by the symbol random determination process) displayed on the display window 150 in the displaying process, a payout table described with reference to FIG. 10, and the number of game media placed as a bet. To be more specific on this payout process, when stop-displayed symbols 501 include any of symbols 501 registered on the payout table shown in FIG. 10, and the number of that any of symbols 501 included is a number registered on the payout table, a certain number of game media is awarded according to the number associated with the number of that any of symbols 501 registered on the payout table. For example, when the plurality of symbols 501 stop-displayed includes three “SEVEN(7)” symbols and the number of game media bet is 30, 100 game media are awarded. In this case, if the number of game media bet is 60, 200 game media are awarded.

(Bonus Game)

The following describes the feature game (bonus game). The bonus game is run when a predetermined bonus game starting condition is established, and includes the continued random determination process, the predetermined symbol displaying process, the second payout process, and the payout upgrading random determination process. In the following, the bonus game starting condition, the continued random determination process, the predetermined symbol displaying process, the second payout process, and the payout upgrading random determination process are described.

(Bonus Game: Bonus Game Starting Condition)

The following describes a condition for starting the bonus game (bonus game starting condition) with reference to FIG. 12. As shown in FIG. 12, the bonus game is run when a predetermined number or more of specific symbols 501 are stop-displayed on any of the payline P10, in the normal game. In other words, the normal game is transited to the bonus game. It should be noted that the specific symbol 501 in the present embodiment is “SEVEN(7)”; however, the specific symbol 501 is not limited to “SEVEN(7)”. Further, the predetermined number or more means three or more; however, the expression is not limited to this, and is suitably set within a range from one or more but not more than five. It should be noted that the “SEVEN(7)” symbols are shaded in the symbol random determination table T1 of FIG. 7. As shown in FIG. 12, in the present embodiment, the “SEVEN(7)” could be stop-displayed in all of the first to fifth reels. Further, in the present embodiment, the bonus game starting condition is to have a predetermined number or more of specific symbols 501 arranged on any of the paylines P10; however, the condition may be stop-displaying of a predetermined number or more of the specific symbols 501 on the display window 150. It should be noted that in the present embodiment, the bonus game starting condition is established at a probability of once in 89.8 times of the normal game.

(Bonus Game: Continued Random Determination Process)

The continued random determination process is a process of executing a continued random determination (corresponding to second random determination) which determines whether to display a predetermined symbol 501 on the display window 150 of the reel device M1. The continued random determination is a type of random determination different from the symbol random determination of the normal game. While the symbol random determination is a type of random determination which determines the symbols 501 themselves to be stop-displayed, the continued random determination is not a type of random determination that determines the symbols 501 to be stop-displayed. In the continued random determination, the predetermined symbol 501 to be stop-displayed is fixed, and whether to stop-display this fixed predetermined symbol 501 (“SEVEN(7)” in the present embodiment) is determined. Thus, as the random determination related to displaying of symbols 501, the slot machine 10 executes not only the symbol random determination for determining symbols 501 (ordinary random determination), but also the continued random determination which determines whether to display a predetermined symbol 501. This increases the number of types of executable random determination. By increasing the number of types of random determination for displaying symbols 501, it is possible to make games (normal game, bonus game) run in the gaming machine more interesting with wider variation. It should be noted that determining to display the predetermined symbol 501 in the continued random determination may be expressed as winning the continued random determination. Further, determining not to display the predetermined symbol 501 in the continued random determination may be expressed as losing the continued random determination.

(Bonus Game: Continued Random Determination Process: Continued Random Determination Table T3)

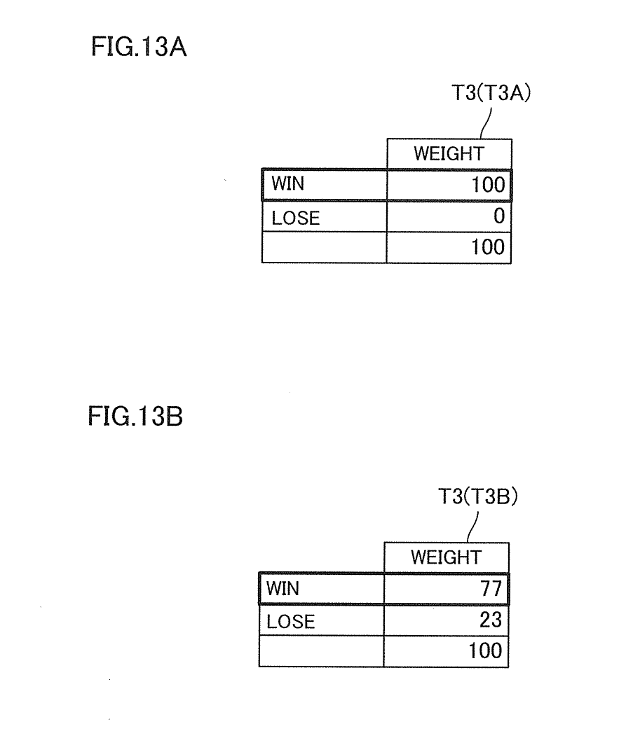

The following describes a continued random determination table T3 used in the continued random determination, with reference to FIG. 12, FIG. 13A, and FIG. 13B. FIG. 13A shows a continued random determination table T3 (T3A) used in the continued random determination of the first time. FIG. 13B shows a continued random determination table T3 (T3B) used in the continued random determination of the second time and thereafter. In the present embodiment, the weight for a win (winning) is 100 and the weight for a loss (losing) is 0, in the continued random determination table T3A of the first time, as shown in FIG. 13A. Therefore, the continued random determination of the first time always results in a winning: i.e., stop-displaying of the “SEVEN(7)” symbol and awarding of a payout always occurs at least once.

In the continued random determination table T3B for the continued random determination of the second time on the other hand, the weight for a win (winning) is 77 and the weight for a loss (losing) is 23, as shown in FIG. 13B. Therefore, there is a chance of winning not occurring in the continued random determination of the second time and thereafter.

It should be noted that in the continued random determination table T3, predetermined different number ranges are associated with the win and loss of the continued random determination so as to meet the weights described hereinabove. In the continued random determination, a random number is generated and the continued random determination results in a win if the random number falls within the predetermined number range associated with the win of the continued random determination. On the other hand, the continued random determination results in a loss when the random number falls within the predetermined number range associated with the loss of the continued random determination.

After transition to the bonus game, the continued random determination is executed for stop-displaying of the “SEVEN(7)” symbol for the first time, in the present embodiment, as hereinabove described. The continued random determination may be omitted for the stop-displaying of the S“SEVEN(7)” symbol for the first time.

(Bonus Game: Predetermined Symbol Displaying Process)

The predetermined symbol displaying process is a process of displaying the “SEVEN(7)” symbol on the display window 150 of the reel device M1, based on the result of the continued random determination process. In this process, the number of “SEVEN(7)” symbols stop-displayed in the bonus game as the result of winning the continued random determination is basically the same as the number of “SEVEN(7)” symbols displayed in the unit normal game triggering execution of the bonus game (unless later-described step-up random determination results in a winning). For example, when three “SEVEN(7)” symbols are stop-displayed in the unit normal game triggering execution of the bonus game, three “SEVEN(7)” symbols are basically stop-displayed (3 of a kind) when the continued random determination results in winning. For example, when four “SEVEN(7)” symbols are stop-displayed in the unit normal game triggering execution of the bonus game, four “SEVEN(7)” symbols are basically stop-displayed (4 of a kind) when the continued random determination results in winning. For example, when five “SEVEN(7)” symbols are stop-displayed in the unit normal game triggering execution of the bonus game, five “SEVEN(7)” symbols are basically stop-displayed (5 of a kind) when the continued random determination results in winning.

Based on the number of “SEVEN(7)” symbols displayed in the unit normal game, a bonus type is set selectively from three bonus types which are the 3 of a kind combination of “SEVEN(7)”, the 4 of a kind combination of “SEVEN(7)”, and the 5 of a kind combination of “SEVEN(7)”, in the present embodiment as described above. In the present embodiment, the bonus type selectively set is referred to as selected bonus type. It should be noted that the number of types of bonus is not limited three types, and may be two types or four types or more. The plurality of bonus types each may be associated with the number of specific symbols 501 and the display window 150 of the reel device M1 displays the same number of specific symbols 501 as the number associated with the selected bonus type, in the predetermined symbol displaying process.

It should be noted that screens displayed in the predetermined symbol displaying process are detailed in the section of (Displaying of Bonus Game).

(Bonus Game: Second Payout Process)

The following describes the second payout process with reference to FIG. 10.

The second payout process is a process of awarding a payout (corresponding to the second payout), based on the “SEVEN(7)” symbols stop-displayed (i.e., based on the predetermined symbols determined in the continued random determination process). Specifically, when the “SEVEN(7)” is stop-displayed, game media is paid out. The amount of payout (the number of game media awarded) is different, depending on the number of “SEVEN(7)” symbols stop-displayed, in the present embodiment. The amount of payout is determined based on the payout table shown in FIG. 10. How the amount of payout is determined is specifically described in the section of Payout Table hereinabove.

As hereinabove described, when the bonus game is started, the selected bonus type is set selectively from three bonus types which are the 3 of a kind combination of “SEVEN(7)”, the 4 of a kind combination of “SEVEN(7)”, and the 5 of a kind combination of “SEVEN(7)”, in the present embodiment as described above. The payout is awarded based on the amount of payout corresponding to the set selected bonus type.

It should be noted that, in the present embodiment, the continued random determination is repeated as long as the continued random determination results in winning, during the bonus game. The predetermined symbol displaying process and the second payout process are executed the same number of times as the number of winnings of the continued random determination. The number of times the predetermined symbol displaying process and the second payout process are repeated is the same as the number of times winning is resulted in the continued random determination. After repeating the predetermined symbol displaying process and the second payout process that number of times, transition occurs from the bonus game to the normal game.

(Bonus Game: Payout Upgrading Random Determination Process)

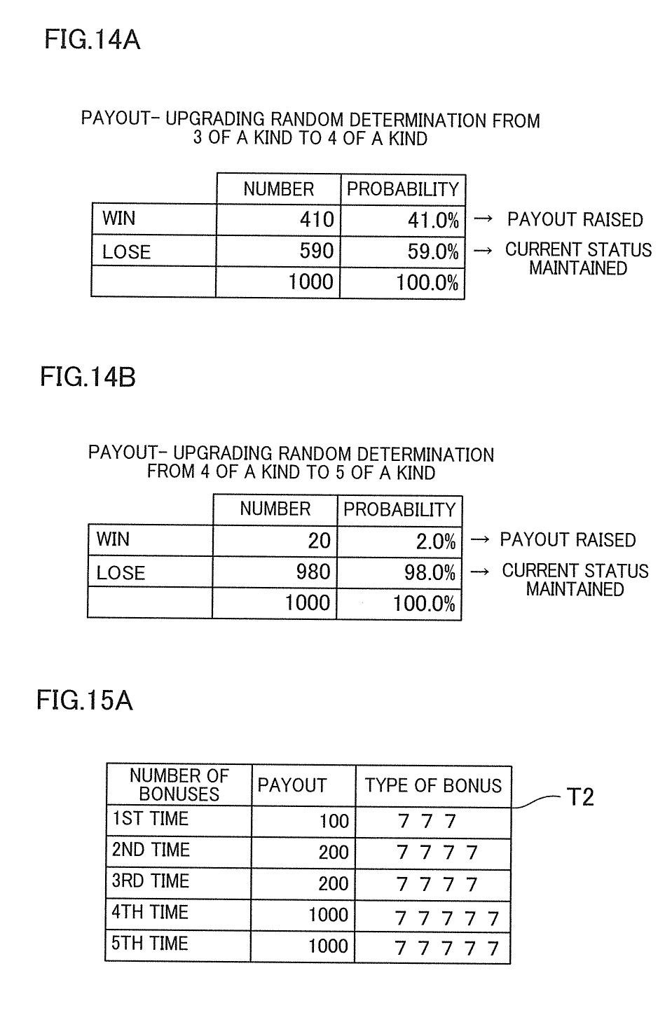

The following describes the payout upgrading random determination process with reference to FIG. 10, FIG. 14A, and FIG. 14B.

The payout upgrading random determination process is a process of executing the payout upgrading random determination (corresponding to the third random determination of the present invention) every time the continued random determination process is executed, to determine whether to make a transition from the set selected bonus type to another bonus type associated with an amount of payout higher than the set selected bonus type; and In the following description, winning the payout upgrading random determination means that transition to another bonus type associated with a higher amount of payout than the set selected bonus type is determined as to occur as the result of the payout upgrading random determination. Losing the payout upgrading random determination means that transition to another bonus type associated with a higher amount of payout than the set selected bonus type is determined as not to occur as the result of the payout upgrading random determination.

As shown in FIG. 10, there are three bonus types in the present embodiment, which are the 3 of a kind combination of “SEVEN(7)”, the 4 of a kind combination of “SEVEN(7)”, and the 5 of a kind combination of “SEVEN(7)”, and the amounts of payout associated with these bonus types are different from one another. A payout of 100 game media is associated with the 3 of a kind combination of “SEVEN(7)”. A payout of 200 game media is associated with the 4 of a kind combination of “SEVEN(7)”. A payout of 1000 game media is associated with the 5 of a kind combination of “SEVEN(7)”. When the set selected bonus type is the 3 of a kind combination of “SEVEN(7)”, the payout upgrading random determination determines whether to upgrade (step up) the payout to that for a 4 of a kind combination of “SEVEN(7)”. When the set selected bonus type is the 4 of a kind combination of “SEVEN(7)”, the payout upgrading random determination determines whether to upgrade (step up) the payout to that for the 5 of a kind combination of “SEVEN(7)”. It should be noted that, when the set selected bonus type is the 5 of a kind combination of “SEVEN(7)”, the payout upgrading random determination process is not executed, because there is no bonus type associated with a higher amount of payout than this bonus type.

The slot machine 10 executes a process of setting the other bonus type as the selected bonus type when the transition to the other bonus type is determined as to be made in the payout upgrading random determination (a process of updating the selected bonus type setting). This way, the amount of payout to be awarded in the second payout process is based on the newly set (updated) selected bonus type.

It should be noted that, in the present embodiment, the payout upgrading random determination process is executed after the continued random determination of the second time and every time the continued random determination is executed thereafter, to determine whether to make a transition to another bonus type by the payout upgrading random determination. In other words, the payout upgrading random determination process is not executed after the continued random determination process of the first time, until the end of the continued random determination of the second time.

(Bonus Game: Payout Upgrading Random Determination Process: Probability of Winning Payout Upgrading Random Determination)

The following describes the probability of winning the payout upgrading random determination with reference to FIG. 14A, and FIG. 14B. FIG. 14A indicates a winning probability of winning the payout upgrading random determination, when the set selected bonus type is the 3 of a kind combination of “SEVEN(7)”. FIG. 14B indicates a winning probability of winning the payout upgrading random determination, when the set selected bonus type is a 4 of a kind combination of “SEVEN(7)”. In cases of the 3 of a kind combination of “SEVEN(7)”, the probability of winning the payout upgrading random determination is 41 percent. On the other hand, a winning probability of winning the payout upgrading random determination is only 2 percent, when the set selected bonus type is a 4 of a kind combination of “SEVEN(7)”. Therefore, the probability of the selected bonus type transiting from the 4 of a kind combination of “SEVEN(7)” to the 5 of a kind combination of “SEVEN(7)” is remarkably lower than the probability of the selected bonus type transiting from the 3 of a kind combination of “SEVEN(7)” to the 4 of a kind combination of “SEVEN(7)”.

It should be noted that predetermined different number ranges are associated with the win and loss of the payout upgrading random determination. In the payout upgrading random determination, a random number is generated and the payout upgrading random determination results in a win if the random number falls within the predetermined number range associated with the win of the payout upgrading random determination. On the other hand, the payout upgrading random determination results in a loss when the random number falls within the predetermined number range associated with the loss of the payout upgrading random determination.

(Bonus Game: Payout Upgrading Random Determination Process: Bonus Information Table T2)

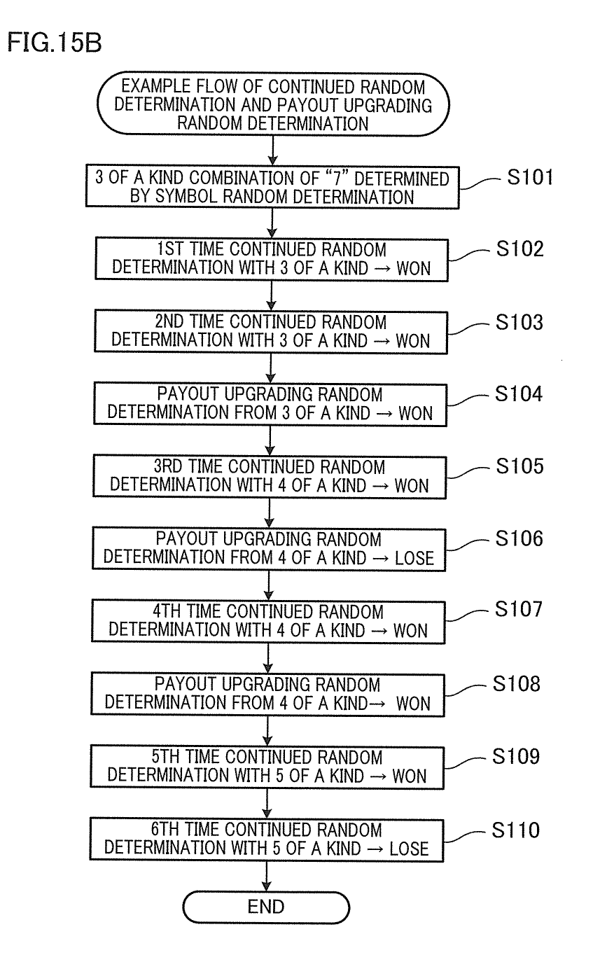

The following describes, with reference to FIG. 15A and FIG. 15B, a bonus information table T2 to which results of the continued random determination and the payout upgrading random determination are registered. In the present embodiment, the payout upgrading random determination process is executed after the continued random determination process is executed in the bonus game. Then, a set of the continued random determination process and the payout upgrading random determination process is repeated until winning is not resulted from the continued random determination process. The results of the continued random determination process and the payout upgrading random determination process are registered on the bonus information table T2 shown in FIG. 15A. Then, based on the information registered on the bonus information table T2, the predetermined symbol displaying process and the second payout process are repetitively executed the same number of times as the number of times the continued random determination process is executed. In the present embodiment described above, the flow of the bonus game (the number of times the “SEVEN(7)” is stopped, and the number of “SEVEN(7)” symbols stopped, the number of times the second payout is awarded, and the amount of the second payout) are determined by executing in advance the continued random determination process and the payout upgrading random determination process at the time of starting the bonus game, and then the predetermined symbol displaying process and the second payout process are executed according to the flow determined.

Referring to FIG. 15A, on the bonus information table T2 are registered the sequential positions of each bonus, and the payout amount and the selected bonus type (set selected bonus types) associated with the bonus of in the sequential position. It should be noted that the Bonus in the Repetition of Bonus means a set of the predetermined symbol displaying process and the second payout process, and the Repetition of Bonus indicates the number of times the set of the predetermined symbol displaying process and the second payout process is executed, and corresponds to the number of times winning has resulted in the continued random determination. For example, FIG. 15B shows that the continued random determination has resulted in winning five times, and in this case the bonus is executed five times. Therefore, bonuses for the first time to the fifth time are registered on the bonus information table T2. The selected bonus type associated with the bonus of the first time is the 3 of a kind combination of “SEVEN(7)”, and an amount of payout associated with the bonus of the first time is 100. Therefore, in the bonus of the first time, three “SEVEN(7)” symbols are stop-displayed (3 of a kind combination) in the predetermined symbol displaying process, and a payout of 100 game media is awarded in the second payout process.

It should be noted that, as hereinabove described, the payout upgrading random determination is executed after the continued random determination of the first time in the present embodiment. Therefore, the selected bonus type registered in association with the bonus of the first time is determined based on the number of “SEVEN(7)” symbols stop-displayed on the payline P10 in the normal game triggering the bonus game. As such, the bonus information table T2 shown in FIG. 15A is a table for a case where three “SEVEN(7)” symbols have stopped in the normal game triggering the bonus game.

The following describes, with reference to FIG. 15B, the results of the continued random determination and the payout upgrading random determination, with conditions registered are as shown in the bonus information table T2 of FIG. 15A. First, a 3 of a kind combination of “SEVEN(7)” is determined in the symbol random determination of the normal game (step S101), and the 3 of a kind combination of “SEVEN(7)” is stop-displayed. This way, the normal game is transited to the bonus game. Then, the continued random determination of the first time results in winning (step S102), and since this is the continued random determination of the first time, the payout upgrading random determination is not executed. Then, the selected bonus type is determined based on the 3 of a kind combination of “SEVEN(7)” stop-displayed in the normal game. Therefore, on the bonus information table T2, the selected bonus type of the 3 of a kind combination of “SEVEN(7)” and the payout amount of 100 are registered in association with the first time in the Repetition of Bonus field.

Then, the continued random determination of the second time results in winning (step S103), and the payout upgrading random determination is executed and results in winning (step S104). Therefore, on the bonus information table T2, the selected bonus type of a 4 of a kind combination of “SEVEN(7)” and the payout amount of 200 are registered in association with the second time in the Repetition of Bonus field. Further, the continued random determination of the third time results in winning (step S105), and the payout upgrading random determination is executed and does not result in winning (step S106). Therefore, on the bonus information table T2, the selected bonus type of the 4 of a kind combination of “SEVEN(7)” and the payout amount of 200 are registered in association with the third time in the Repetition of Bonus field. Then, the continued random determination of the fourth time results in winning (step S107), and the payout upgrading random determination is executed and results in winning (step S108). Therefore, on the bonus information table T2, the selected bonus type of the 5 of a kind combination of “SEVEN(7)” and the payout amount of 1000 are registered in association with the fourth time in the Repetition of Bonus field. Further, the continued random determination of the fifth time results in winning (step S109), and since the 5 of a kind combination of “SEVEN(7)” is the highest ranked bonus type, the payout upgrading random determination is not executed. Therefore, on the bonus information table T2, the selected bonus type of the 5 of a kind combination of “SEVEN(7)” and the payout amount of 1000 are registered in association with the fifth time in the Repetition of Bonus field. Further, the continued random determination of the sixth time does not result in winning (step S110), and the process of updating the bonus information table T2 is ended.

(Bonus Game: Payout Upgrading Random Determination Process: Effect According to Selected Bonus Type)

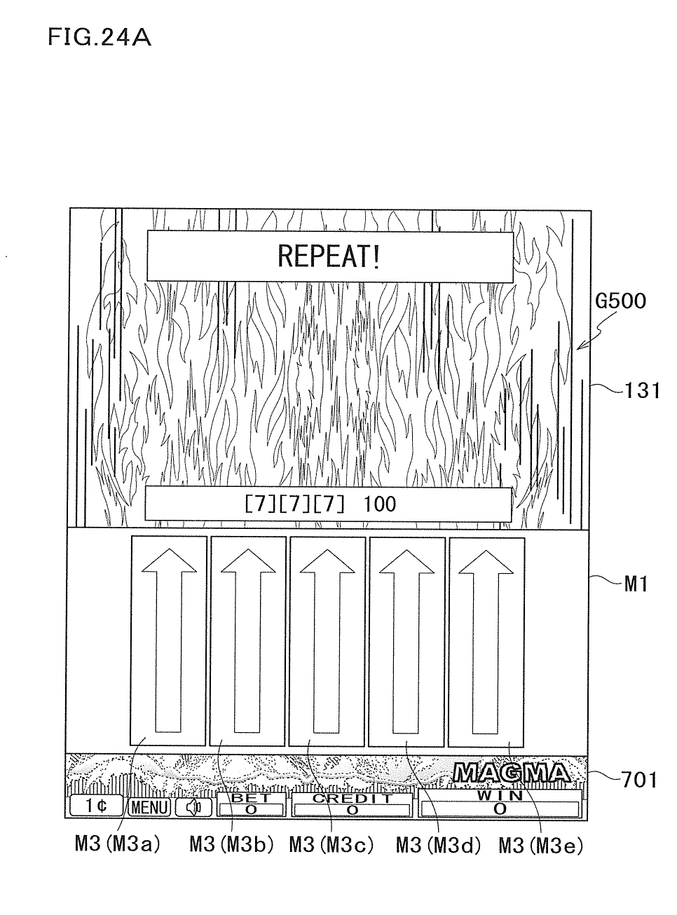

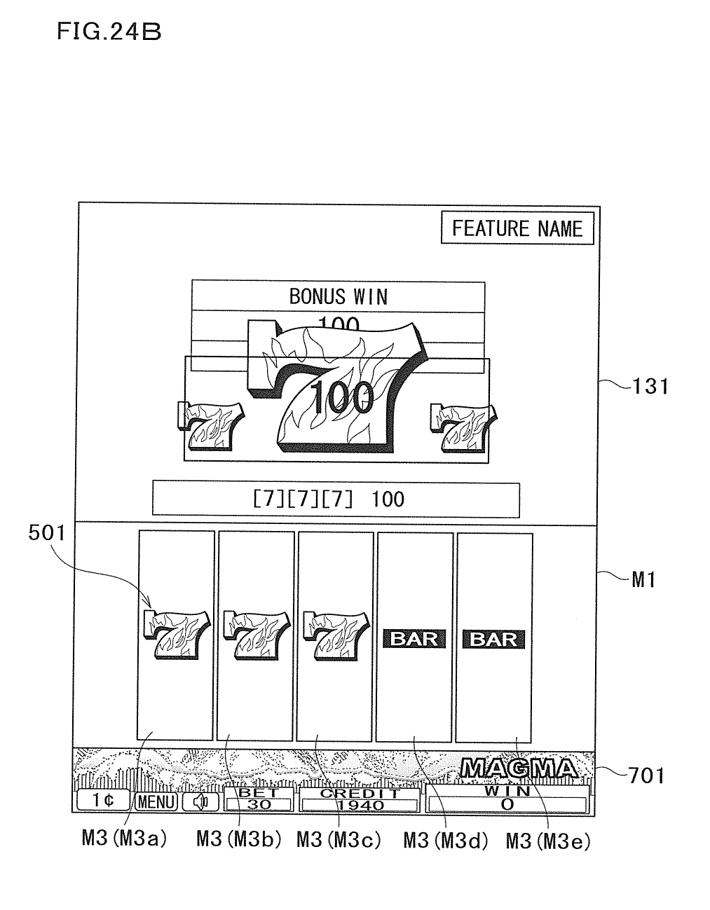

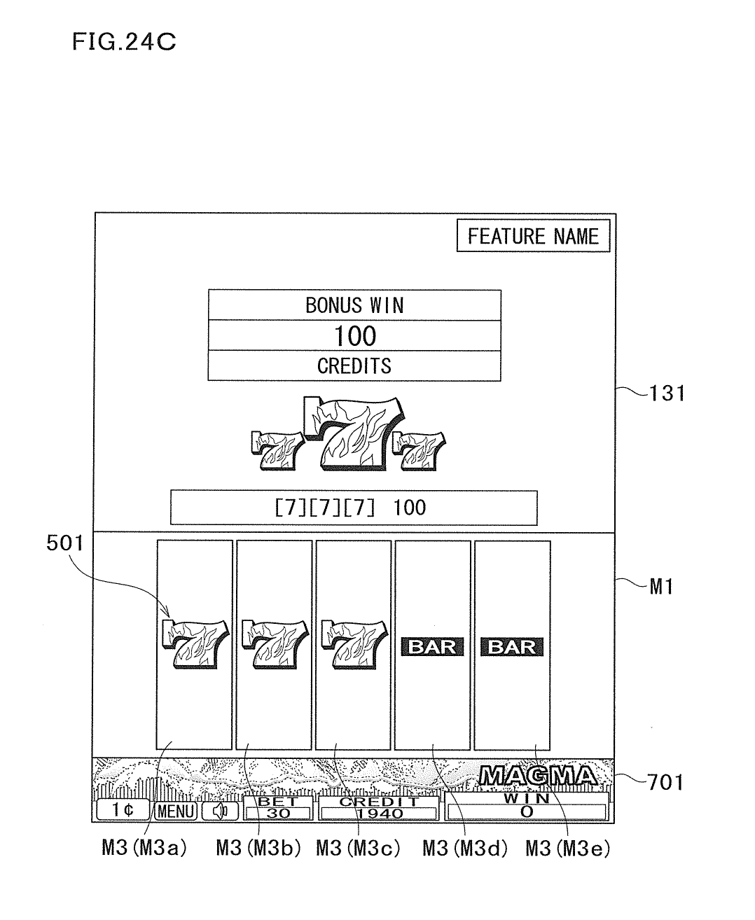

The following describes effects according to the selected bonus type, with reference to FIG. 24A. For a 3 of a kind combination of “SEVEN(7)”, the 4 of a kind combination of “SEVEN(7)”, and the 5 of a kind combination of “SEVEN(7)”, different effects are associated, respectively. An effect associated with the set selected bonus type is executed before the predetermined symbol displaying process is executed. The effects may be in the form of sound, illumination, or display contents on the display device. In the present embodiment, an effect image G500 of flame shown in FIG. 24A is displayed before displaying of the “SEVEN(7)” symbols, and the color of the flame is different depending on the set selected bonus types. For example, the flame is displayed in blue for the 3 of a kind combination of “SEVEN(7)”, in yellow for the 4 of a kind combination of “SEVEN(7)”, and in red for the 5 of a kind combination of “SEVEN(7)”. This way, the flame serves as an indication effect that enables the player to predict the bonus type about to occur and the amount of payout to be paid. It should be noted that the present embodiment deals with a case of changing the color of the flame; however, it is possible to change the color of a different item object displayed.

(Bonus Game: Displaying of Reels M3)

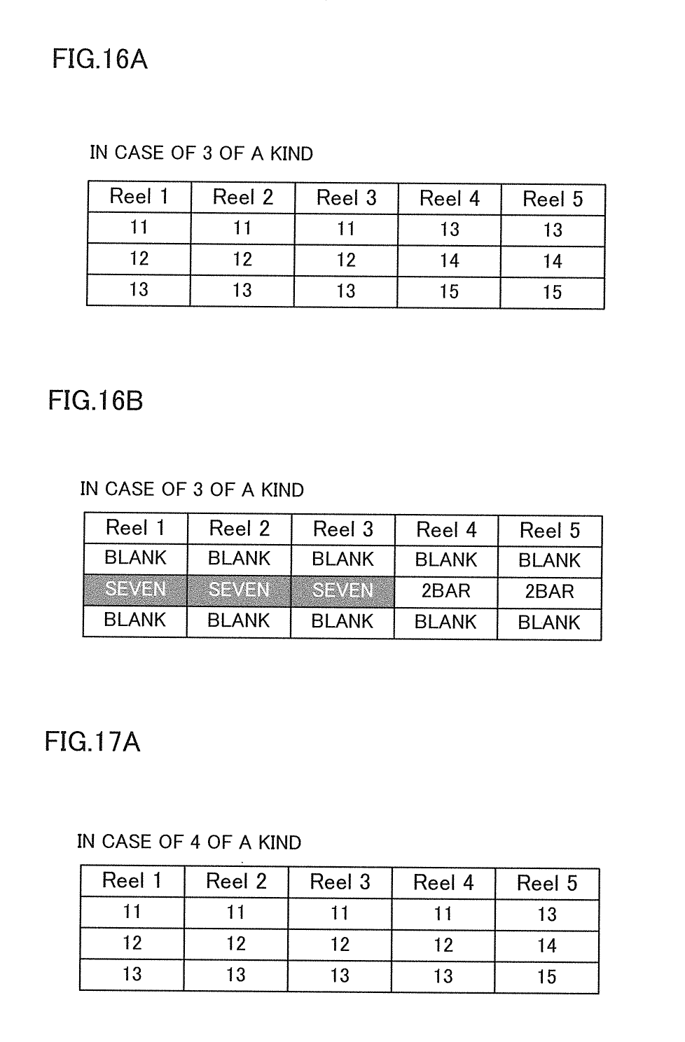

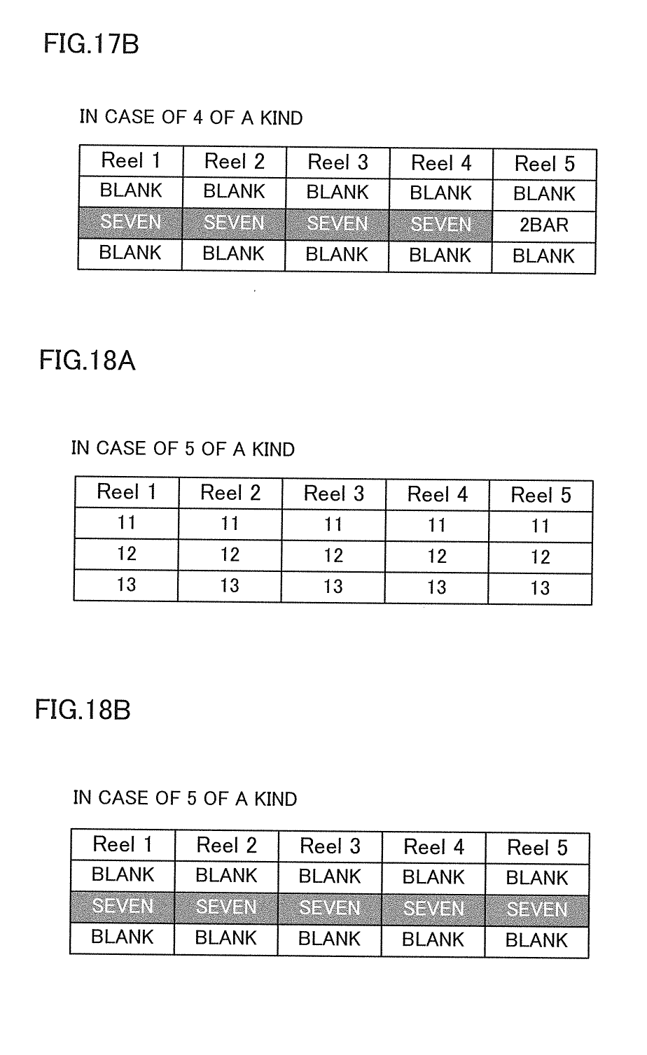

The following describes displaying of the reels M3, with reference to FIG. 6A to FIG. 6E, FIG. 16A, FIG. 16B, FIG. 17A, FIG. 17B, FIG. 18A, and FIG. 18B. As described in the section of (Paylines), the first to third paylines P10a, P10b, P10c are aligned in the vertical direction, and a V-shaped fourth payline P10d and a counter V-shaped fifth payline P10e are also arranged, on the display window 150.

The bonus game is executed when the specific symbol 501 (“SEVEN(7)”) is stop-displayed in a position corresponding to any one of the five paylines P10, in the normal game triggering the bonus game. However, as shown in FIG. 16A, FIG. 16B, FIG. 17A, FIG. 17B, FIG. 18A, and FIG. 18B, even when the game has transited to the bonus game, as the result of “SEVEN(7)” stopping on any one of the five paylines P10 in the normal game, the “SEVEN(7)” symbol in the bonus game is always stop-displayed on the payline P10b in the bonus game. Specifically, in the predetermined symbol displaying process of the bonus game, the “SEVEN(7)” symbol is displayed in a position corresponding to a payline P10 out of three paylines (first to third paylines P10a to P10c) other than the first and third paylines P10a and P10c in the uppermost or lowermost, i.e., a payline P10b, and no “SEVEN(7)” symbol is displayed in positions corresponding to the first and third paylines P10a and P10c in the uppermost or lowermost. Thus, the “SEVEN(7)” symbols are displayed with a good visibility to the player. As shown in FIG. 7, positions above and below the “SEVEN(7)” symbol are blank (no symbols), in the present embodiment. Therefore, by stop-displaying the “SEVEN(7)” symbol in a position corresponding to the second payline P10b, the positions corresponding to the first and third paylines P10a and P10c are made blank. As such, symbols 501 to form a winning combination (e.g., BAR and the like) will not be stop-displayed on the first and third paylines P10a and P10c. This prevents formation of a winning combination in the first and third paylines P10a and P10c, when a “SEVEN(7)” symbol is stop-displayed in the bonus game.

(Main Process)

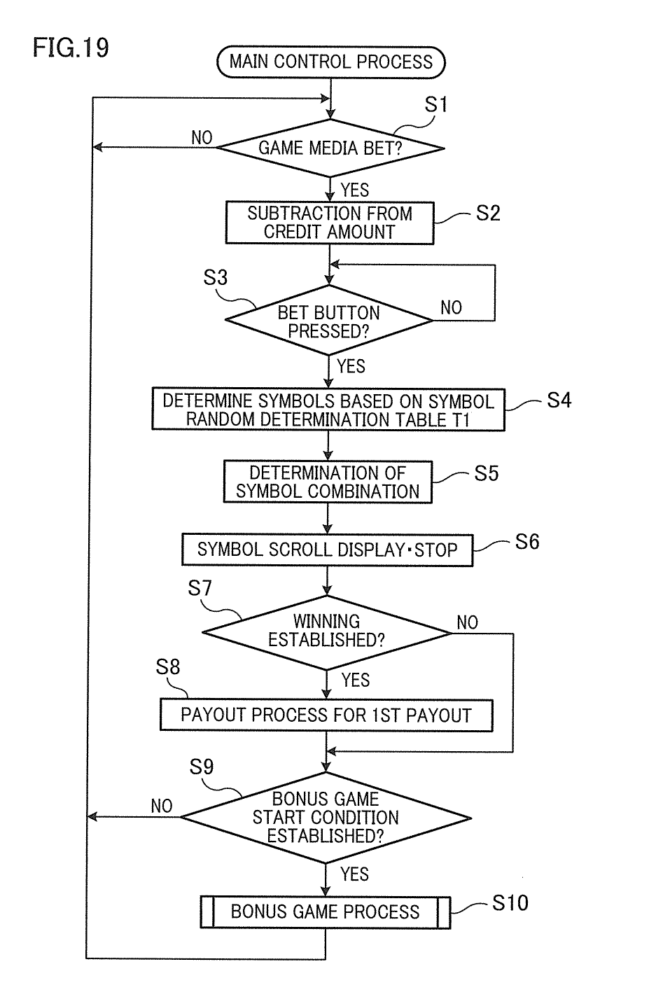

The following describes an example main process executed by the slot machine 10 of the present embodiment with reference to FIG. 19. The main process is executed by the main CPU 71. The main CPU 71 determines whether or not an amount of game media is bet (S1). The main CPU 71 repeats determination of step S1 until it determines that an amount of game media is bet (any of the first bet button 34, second bet button 35, third bet button 36, fourth bet button 37, and fifth bet button 38 is pressed). When the main CPU 71 determines that an amount of game media is bet (S1: Yes), the main CPU 71 subtract from a player-owned credit amount an amount of credit corresponding to the game media placed as a bet (S2).

After that, the main CPU 71 determines whether or not the spin button 46 is pressed by the player (S3). The main CPU 71 repeats determination in step S3 until it determines that the spin button 46 is pressed by the player. When the main CPU 71 determines that the spin button 46 is pressed by the player (S3: Yes), the main CPU 71 determines a plurality of symbols 501 to be displayed on the reel device M1 based on the symbol random determination table T1 (S4). It should be noted that in step S4, a plurality of symbols 501 to be displayed in positions corresponding to the second payline P10b is determined. This also determines indirectly a plurality of symbols 501 to be displayed in positions corresponding to the first, third, fourth, and fifth paylines P10a, P10c, P10d, and P10e.

Then, the main CPU 71 determines whether or not a predetermined symbol combination is established based on the plurality of symbols 501 determined in step S4 (S5). The plurality of symbols 501 determined in step S4 is the plurality of symbols 501 determined as to be displayed in positions corresponding to the first to fifth paylines P10a, P10b, P10c, P10d, and P10e. Then, the main CPU 71 performs reel control so that the reel unit M1 scrolls the reels M3, and causes the reel unit M1 to stop scrolling of the reels M3 so that the plurality of symbols 501 determined in step S4 are stop-displayed in the display window 150 (S6). It should be noted that, in step S6, the symbols 501 may be scrolled or stopped in such a manner as to provide an indication effect based on the predetermined symbol combination determined in step S4.

Then, the main CPU 71 determines whether or not winning is established based on the determination results of step S5 (S7). When the predetermined symbol combination is determined as to be established in step S5, the winning is determined as to be established in step S7. When the winning is determined as to be established (S7: Yes), the main CPU 71 awards a first payout (increase the player-owned credit amount) according to the winning and the bet amount, based on the payout table shown in FIG. 10 (S8). Then, the main CPU 71 proceeds to step S9. Meanwhile, when the winning is not determined as to be established (S7: NO), the main CPU 71 proceeds to step S9, without executing step S8.

In step S9, the main CPU 71 determines whether or not the above-described bonus game starting condition is established based on the plurality of symbols 501 determined in step S4 (the plurality of symbols 501 determined as to be displayed in positions corresponding to the first to fifth paylines P10a, P10b, P10c, P10d, and P10e) (S9). When the bonus game starting condition is determined as to be established (S9: Yes), the main CPU 71 executes the later-described bonus game process (S10), and then returns to step S1. It should be noted that execution of the bonus game process means transition to the bonus game process. Meanwhile, when the bonus game starting condition is not determined as to be established (S9: NO), the main CPU 71 returns to step S1, without executing step S10.

(Bonus Game Process)

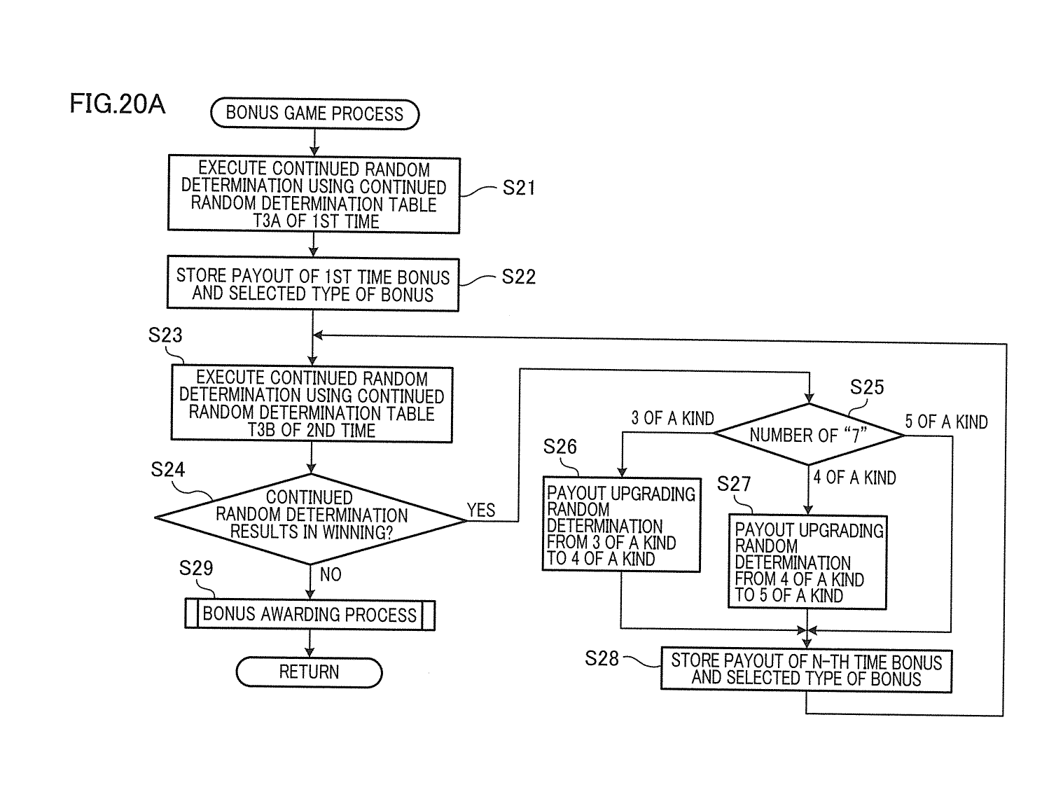

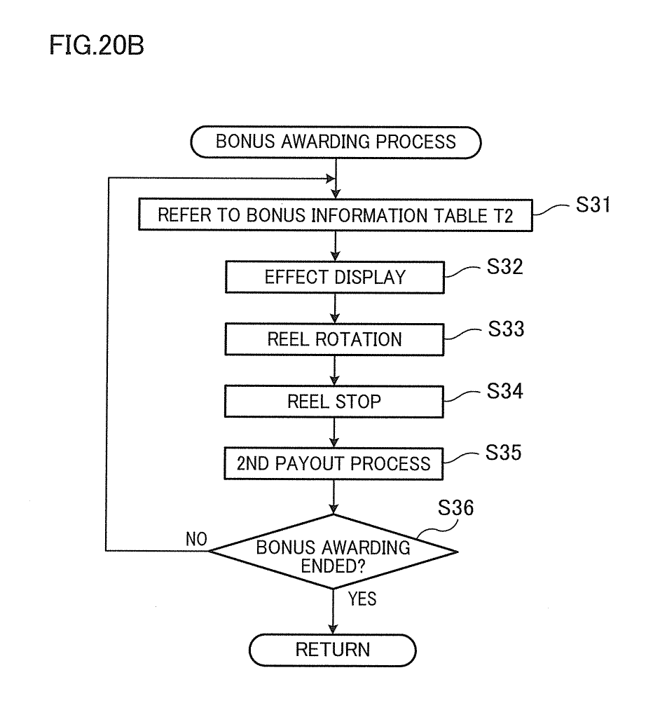

The following describes the bonus game process in step S10 shown in FIG. 19, with reference to FIG. 20A, and FIG. 20B. First, the main CPU 71 executes continued random determination using the continued random determination table T3A (FIG. 13A) for the first time (S21). As hereinabove mentioned, the continued random determination of the first time always results in winning. The main CPU 71 then registers the result of the continued random determination of the first time (the payout amount of the bonus of the first time, and selected bonus type) on the bonus information table T2 (FIG. 14A) (S22). It should be noted that, in this process, the selected bonus type based on the number of “SEVEN(7)” symbols stop-displayed in the normal game triggering the bonus game and the payout amount associated with the selected bonus type are registered. Subsequently, the main CPU 71 executes continued random determination using the continued random determination table T3B (FIG. 13B) for the second time and thereafter (S23). As hereinabove mentioned, the continued random determinations of the second time and thereafter do not always result in winning.

Then, the main CPU 71 determines whether or not winning is resulted in the continued random determination in step S23 (S24). When the continued random determination results in winning (S24: Yes), the main CPU 71 checks the currently set number of “SEVEN(7)” symbols, i.e., currently set selected bonus type (S25). It should be noted that the currently set selected bonus type means the latest-registered selected bonus type on the bonus information table T2.

When the selected bonus type is determined as to be the 3 of a kind combination of “SEVEN(7)” in step S25, the main CPU 71 executes payout upgrading random determination for upgrading from the 3 of a kind combination to the 4 of a kind combination of “SEVEN(7)”, with the winning probability shown in FIG. 14A (S26). Then, the main CPU 71 proceeds to step S28 which is described later. When the selected bonus type is determined as to be a 4 of a kind combination of “SEVEN(7)” in step S25, the main CPU 71 executes payout upgrading random determination for upgrading from the 4 of a kind combination to the 5 of a kind combination of “SEVEN(7)”, with the winning probability shown in FIG. 14B (S27). Then, the main CPU 71 proceeds to step S28 which is described later. When the selected bonus type is determined as to be the 5 of a kind combination of “SEVEN(7)” in step S25, the main CPU 71 proceeds to step S28, without executing payout upgrading random determination. This is because there is no bonus type associated with a higher payout than that of the 5 of a kind combination of “SEVEN(7)” symbols.

In step S28, the main CPU 71 registers, on the bonus information table T2, the result of the continued random determination in step S23 and, if executed, the result of the payout upgrading random determination in step S26 or S27 (the payout amount of the bonus of n-th time and the selected bonus type). It should be noted that if the payout upgrading random determination of step S26 or S27 results in winning, the upgraded bonus type is registered as the selected bonus type on the bonus information table T2. When the current selected bonus type is a 3 of a kind combination of “SEVEN(7)”, the upgraded bonus type is the 4 of a kind combination of “SEVEN(7)”, and is the 5 of a kind combination of “SEVEN(7)”, if the current selected bonus type is the 4 of a kind combination of “SEVEN(7)”. Further, on the bonus information table T2, the payout amount associated with the upgraded selected bonus type is registered. Then, the main CPU 71 returns to step S23.

The following describes a process in cases where the main CPU 71 determines that the continued random determination did not result in winning in step S24. In this case, the main CPU 71 executes stop-displaying of the symbols 501 and the bonus awarding process based on the information registered on the bonus information table T2 (S29). Then, the main CPU 71 ends the bonus game process and returns to the main process.

The following describes the bonus awarding process in step S28, with reference to FIG. 20B. First, the main CPU 71 refers to the bonus information table T2 to obtain information of the selected bonus type of the current bonus, and the payout amount associated with this selected bonus type (S31). Then, the main CPU 71 instructs the graphic board 130 to executes effect display associated with the obtained selected bonus type in step S31, on the upper image display panel 131 or the lower image display panel 701 (S32) For example, an effect image G500 of a flame as shown in FIG. 24A is displayed on the lower image display panel 701. This flame is displayed in various colors depending on the selected bonus type.

Then, after the reels M3 of the reel device M1 are rotated, the main CPU 71 stop-displays a plurality of symbols 501 based on the selected bonus type obtained in step S31 (S34). When the selected bonus type obtained is the 3 of a kind combination of “SEVEN(7)”, three “SEVEN(7)” symbols are displayed in positions corresponding to the second payline P10b of the display window 150, as shown in FIG. 16A and FIG. 16B. When the selected bonus type obtained is the 4 of a kind combination of “SEVEN(7)”, four “SEVEN(7)” symbols are displayed in positions corresponding to the second payline P10b of the display window 150, as shown in FIG. 17A and FIG. 17B. When the selected bonus type obtained is the 5 of a kind combination of “SEVEN(7)”, five “SEVEN(7)” symbols are displayed in positions corresponding to the second payline P10b of the display window 150, as shown in FIG. 18A and FIG. 18B. It should be noted that the steps S31, S33, and S34 correspond to the displaying process of the predetermined symbols.

After that, the main CPU 71 performs the second payout process (S35). In the second payout process, the payout amount obtained in step S31 is awarded as the second payout (the player-owned credit is increased). Then, the main CPU 71 refers to the bonus information table T2 to determine whether to end the bonus awarding process (S36). This process determines if there is any unpaid bonuses, and if there is an unpaid bonus, process results in NO. For example, in a process of awarding the bonus for the third time through step S31 to step S35, the above-process determines there is an unpaid bonus if the bonus for the fourth time is registered on the bonus information table T2. If it is determined that the bonus awarding process is not ended (S36: No), the main CPU 71 returns to step S31 to award the subsequent bonus. On the other hand, if it is determined that the bonus awarding process is ended (S36: Yes), the main CPU 71 ends the bonus awarding process and returns to the bonus game process.

(Display of Normal Game)

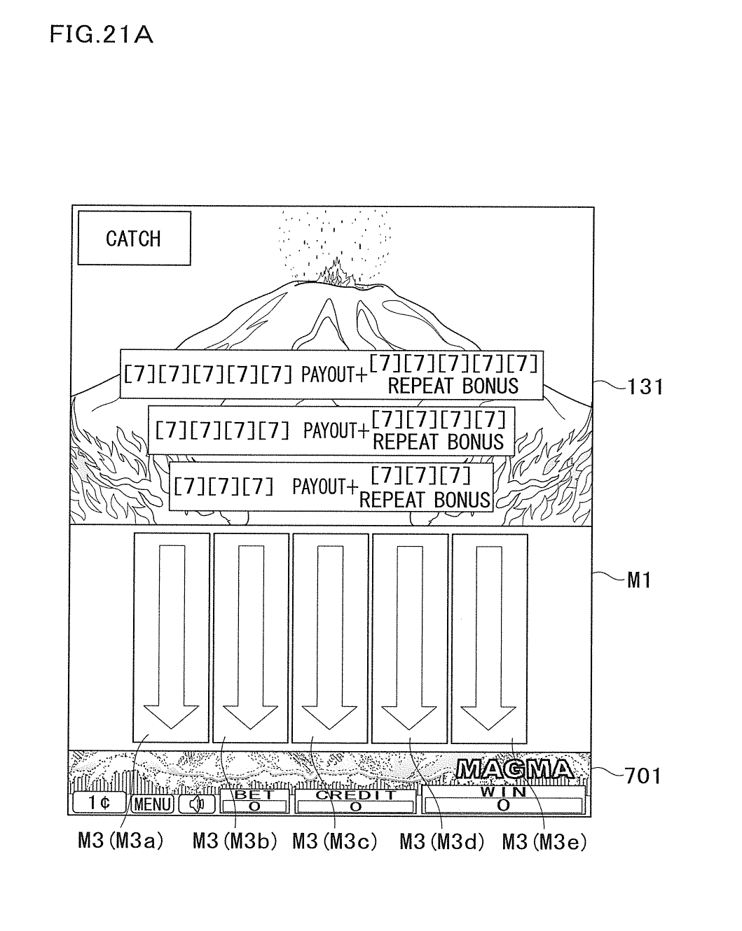

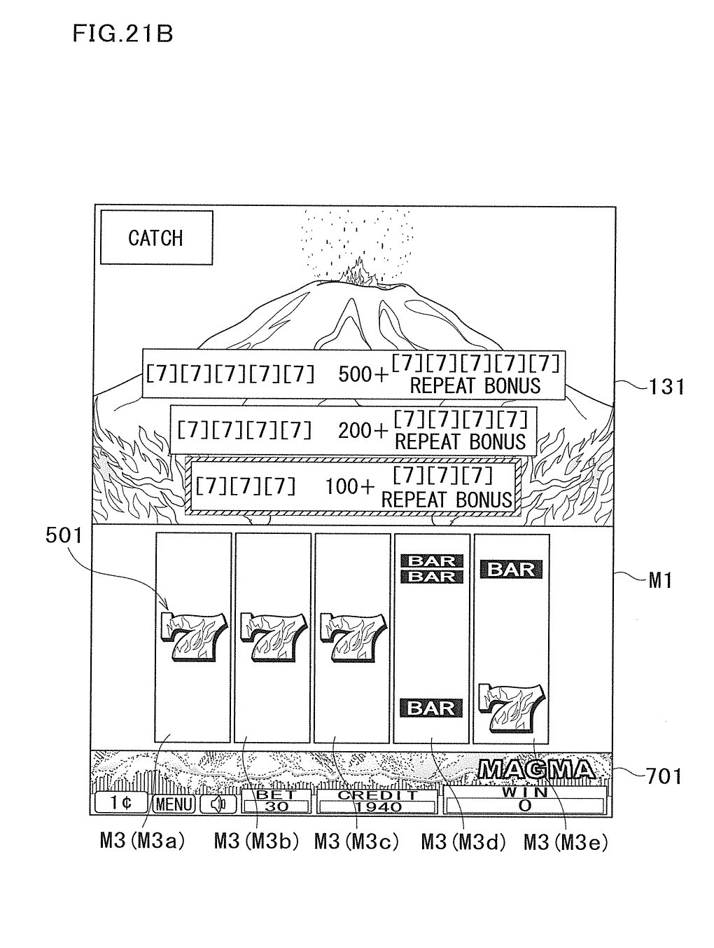

The following describes displays in the normal game on the upper image display panel 131, the reel device M1, and the lower image display panel 701, with reference to FIG. 21A and FIG. 21B. As shown in FIG. 21A, a background image of a volcano is displayed on the upper image display panel 131, while the reels M3 are rotating in the normal game. If, along with this, the 5 of a kind combination of “SEVEN(7)” is stop-displayed, there is an indication that a bonus game (repeated bonus game) will be executed in addition to the first payout. Further, the lower image display panel 701 indicates various information related to the game, such as the bet amount, owned credit amount, and the like. When three or more “SEVEN(7)” symbols are stop-displayed as shown in FIG. 21B, according to the result of the symbol random determination, transition to the normal game to the bonus game occurs.

(Display when Transiting from Normal Game to Bonus Game)

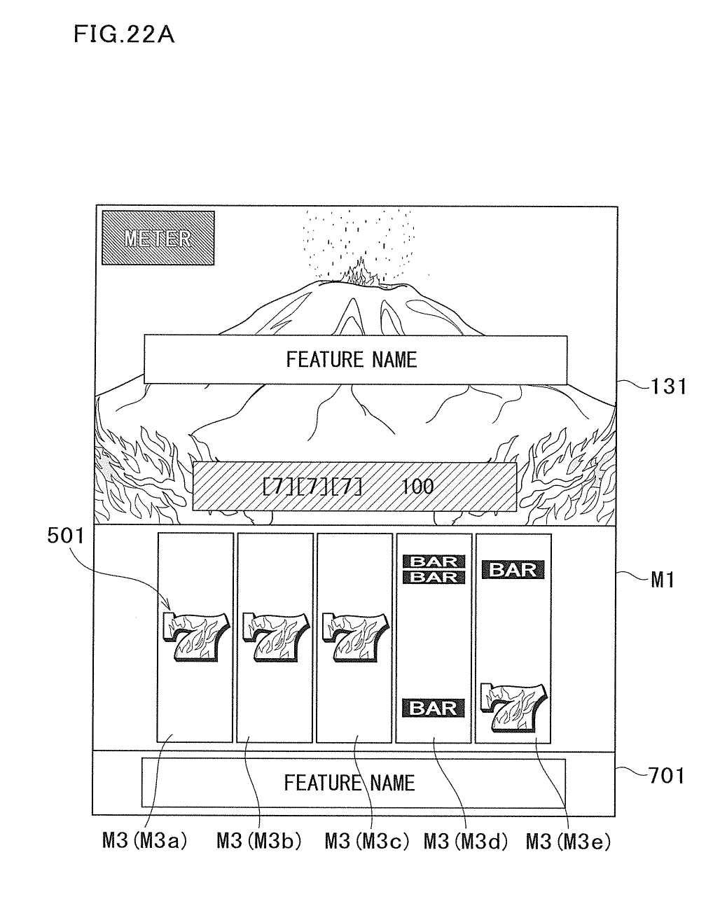

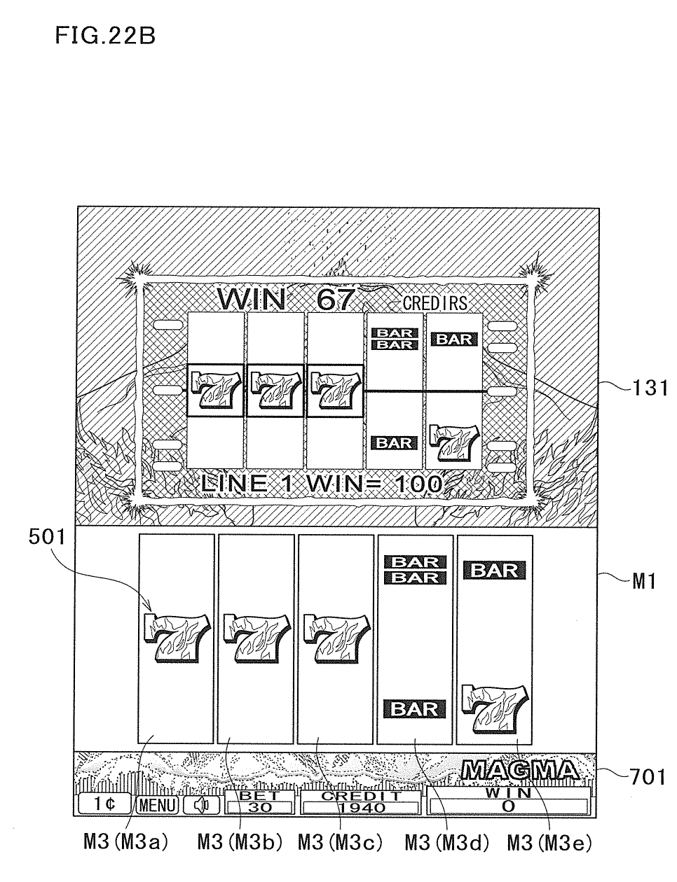

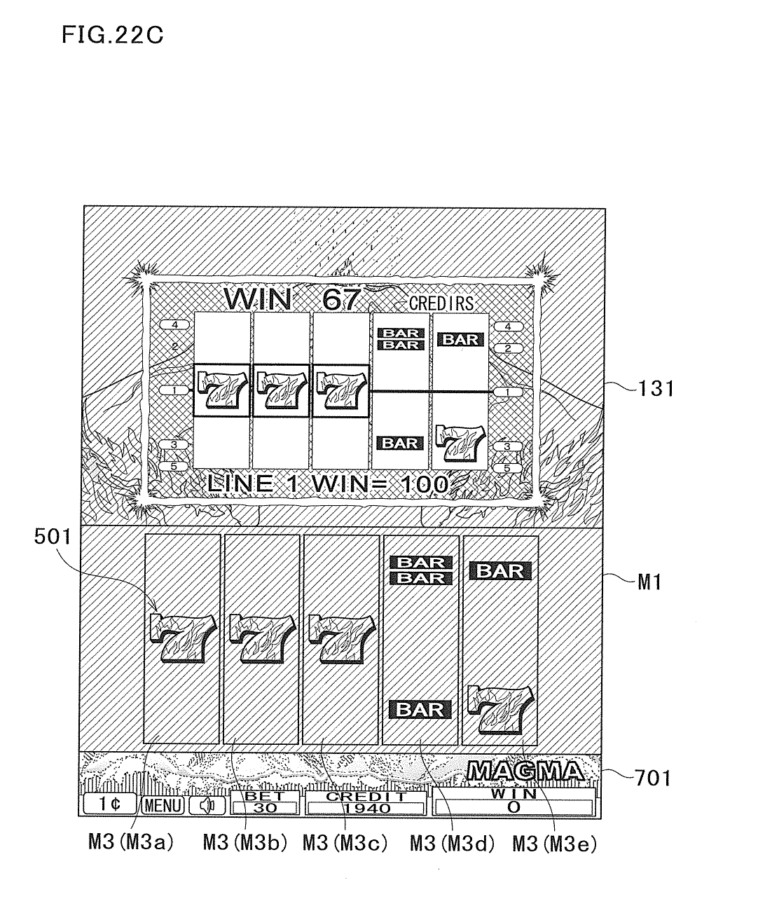

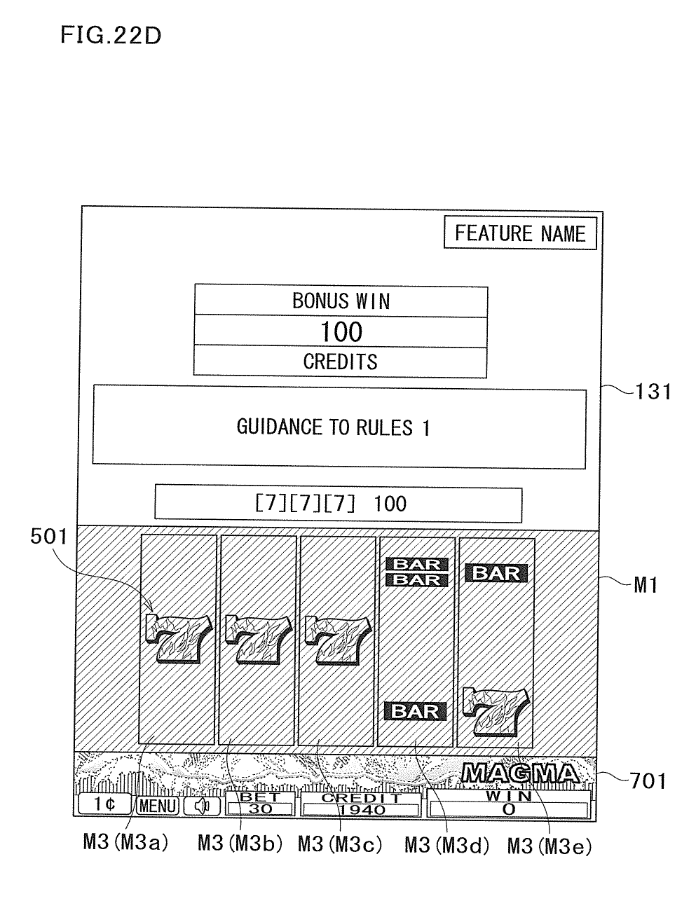

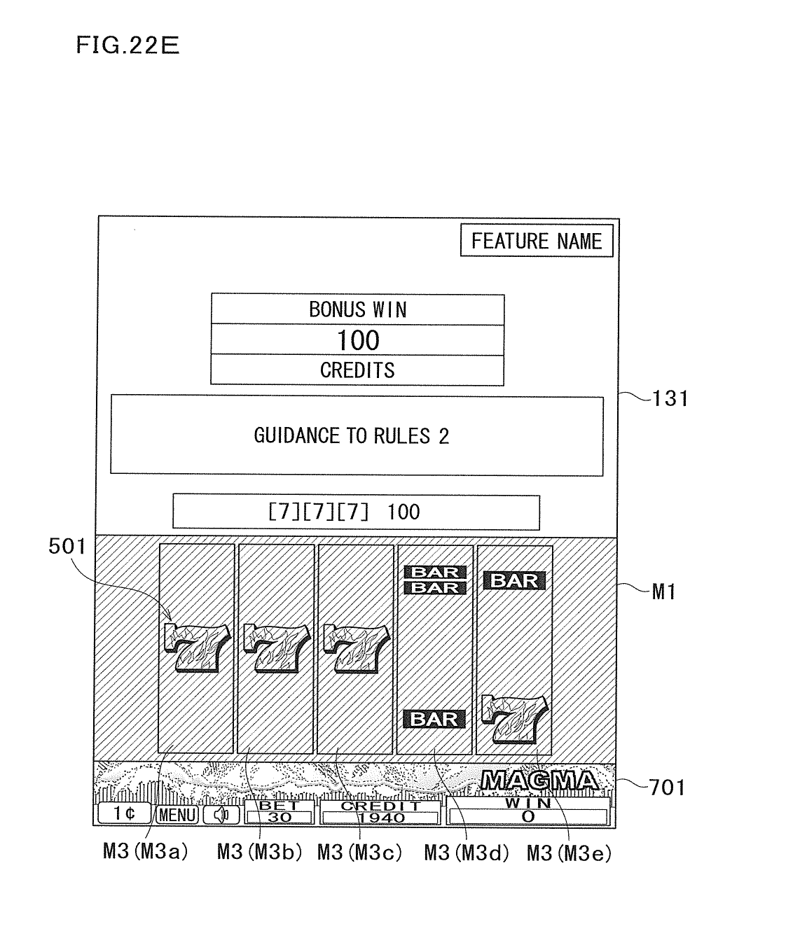

The following describes displays at the time of transition from the normal game to the bonus game, on the upper image display panel 131, the reel device M1, and the lower image display panel 701, with reference to FIG. 22A, FIG. 22B, FIG. 22C, FIG. 22D, and FIG. 22E. As shown in FIG. 22A, a feature name (repeated bonus) is displayed on the upper image display panel 131 and the lower image display panel 701. Then, as shown in FIG. 22B, an effect image that notifies the player that three or more “SEVEN(7)” symbols are stop-displayed is displayed on the upper image display panel 131. Then, as shown in FIG. 22C, the display on the transparent liquid crystal panel arranged on the reel device M1 is darkened, to blackout the reel device M1. After that, as shown in FIG. 22D, the upper image display panel 131 displays guidance to the rules of the bonus game and indicates that the selected bonus type is the 3 of a kind combination of “SEVEN(7)” and the payout amount for the bonus of the first time corresponding to this selected bonus type. Subsequently, display as shown in FIG. 22E is performed, and other rules of the bonus game are displayed.

(Images of Bonus Game: Display at Beginning of Bonus Game)

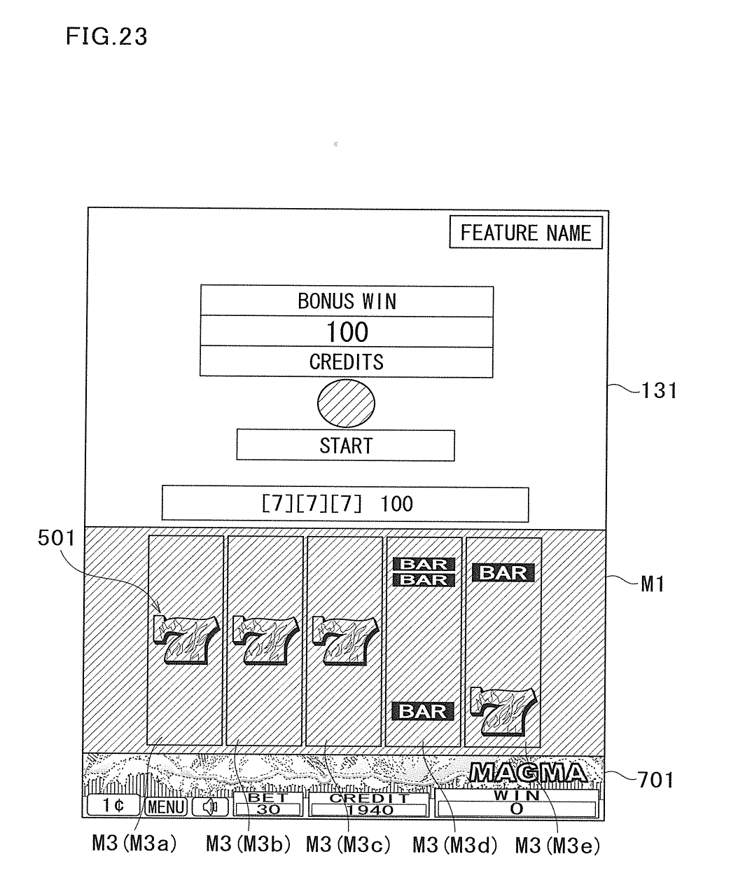

The following describes displays at the time of starting the bonus game on the upper image display panel 131, the reel device M1, and the lower image display panel 701, with reference to FIG. 23. FIG. 23 shows display which follows that shown in FIG. 22E. As shown in FIG. 23, an image prompting the player to press the spin button 46 is displayed on the upper image display panel 131. The above-described bonus game process is executed upon pressing of this spin button 46 or upon elapse of a predetermined period without pressing the spin button 46.

(Images of Bonus Game: When Winning Results in Continued Random Determination, but not in Payout Upgrading Random Determination)

The following describes displays on the upper image display panel 131, the reel device M1, and the lower image display panel 701, when the payout upgrading random determination does not result in winning, with reference to FIG. 24A and FIG. 24B. After the display shown in FIG. 23, the reel device M1 rotates the reels M3 in the opposite direction. Further, the selected bonus type is displayed on the upper image display panel 131, and the effect image G500 of the flame is displayed in a color according to the selected bonus type, as shown in FIG. 24A. Then, as shown in FIG. 24B, a certain number of “SEVEN(7)” symbols corresponding to the selected bonus type are stop-displayed on the reel device M1, and the payout amount corresponding to the selected bonus type is indicated and emphasized on the upper image display panel 131. The display is as shown in FIG. 24C, when the second payout is awarded. Then, the upper image display panel 131, the reel device M1, and the lower image display panel 701 perform displaying as shown in FIG. 23.

(Images of Bonus Game: When Winning Results in Continued Random Determination, and in Payout Upgrading Random Determination for Upgrading from 3 of a Kind to 4 of a Kind)

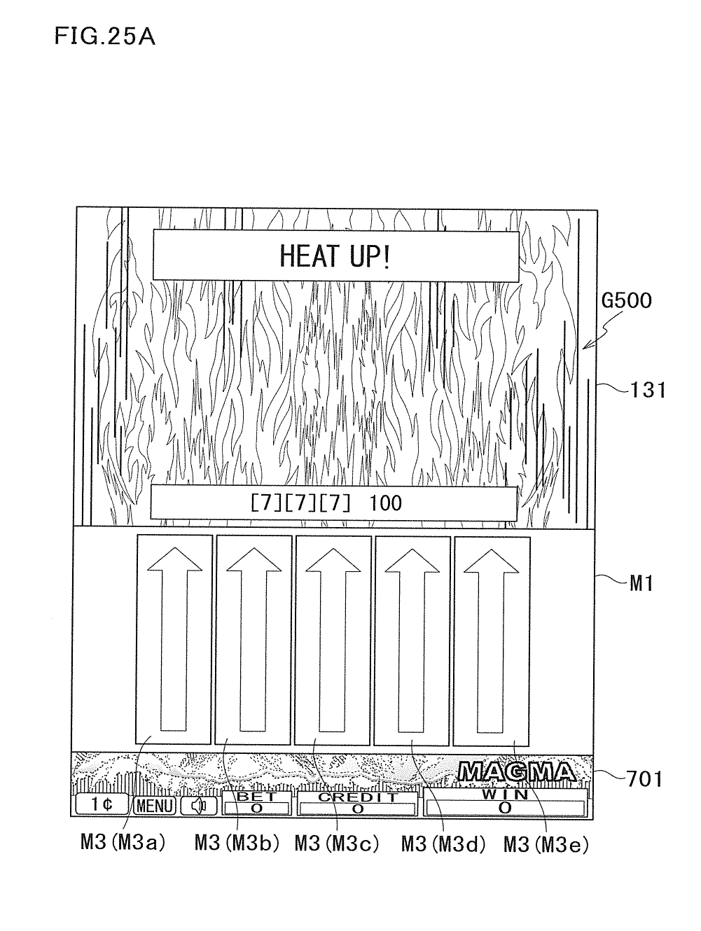

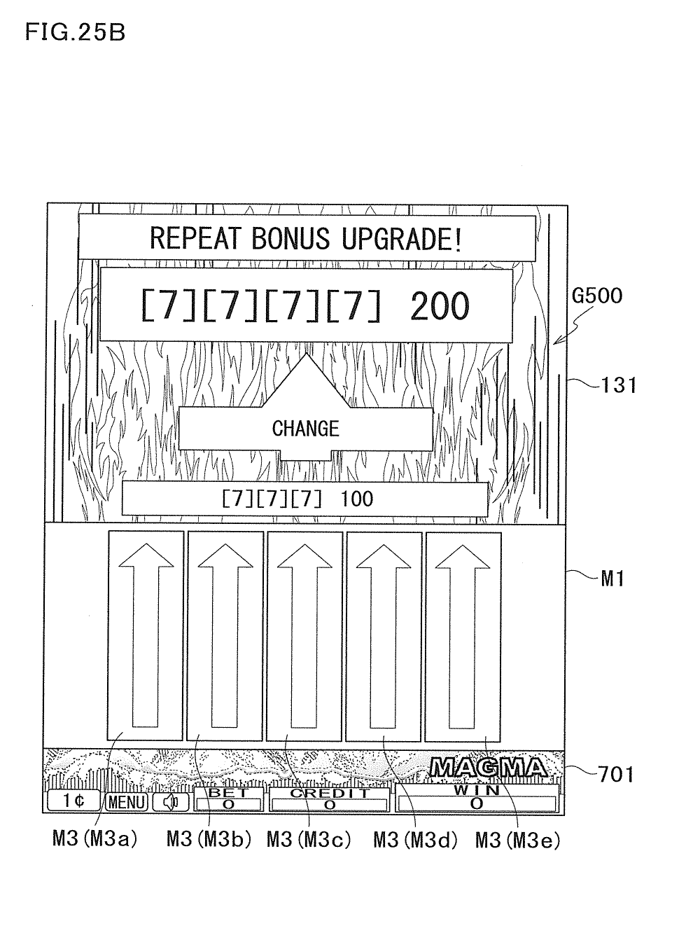

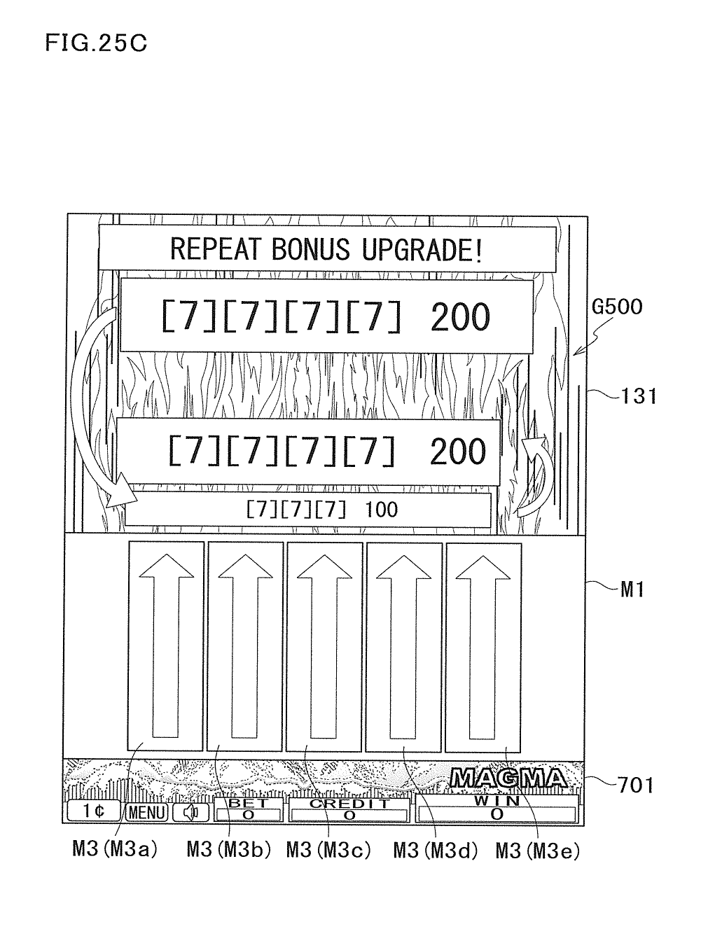

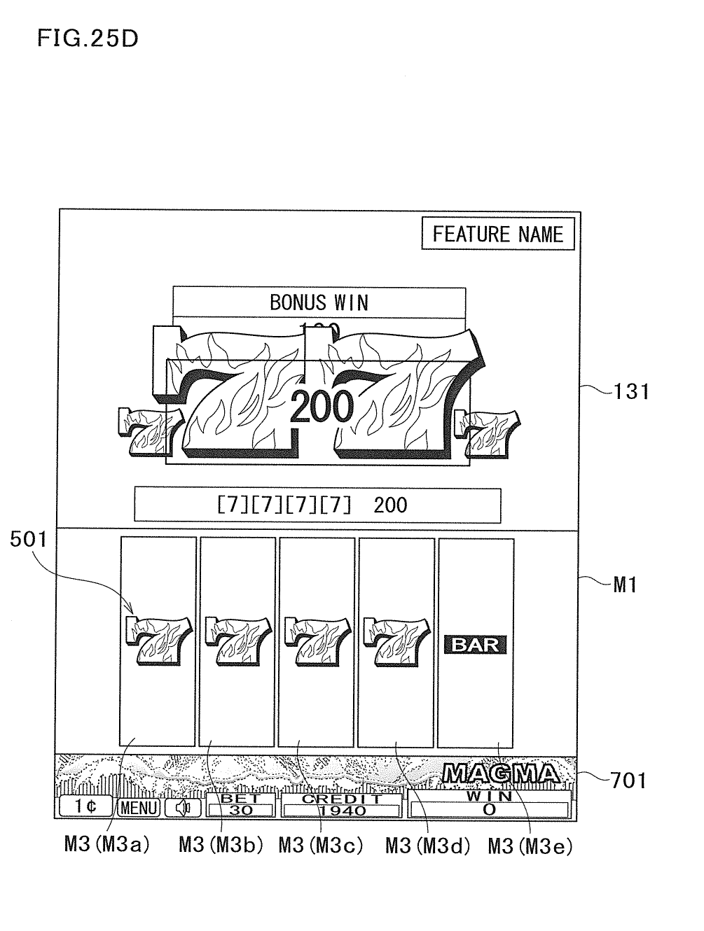

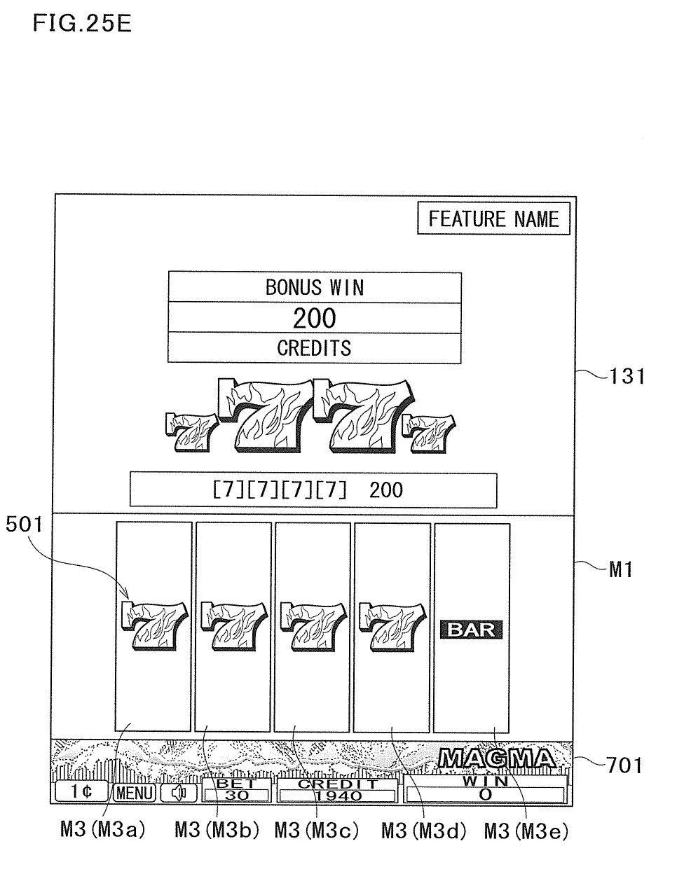

The following describes displays on the upper image display panel 131, the reel device M1, and the lower image display panel 701, when the payout upgrading random determination for upgrading from the 3 of a kind to the 4 of a kind results in winning, with reference to FIG. 25A, FIG. 25B, FIG. 25C, and FIG. 25E. After the display shown in FIG. 23, the reel device M1 rotates the reels M3 in the opposite direction. Further, the selected bonus type is displayed on the upper image display panel 131, and the effect image G500 of the flame is displayed in a color according to the selected bonus type, as shown in FIG. 25A. Then, as shown in FIG. 25B, an image indicating that the upgrading from the 3 of a kind combination to the 4 of a kind combination of “SEVEN(7)” occurred is displayed on the upper image display panel 131. After that, displaying of the 4 of a kind combination of “SEVEN(7)” replaces that of the 3 of a kind combination of “SEVEN(7)”, as indicated by the arrow in FIG. 25C, and displaying of the 4 of a kind combination of “SEVEN(7)” is moved slightly upward. Then, as shown in FIG. 25D, a certain number of “SEVEN(7)” symbols corresponding to the selected bonus type are stop-displayed on the reel device M1, and the payout amount corresponding to the selected bonus type is indicated and emphasized on the upper image display panel 131. The display is as shown in FIG. 25E, when the second payout is awarded. Then, the upper image display panel 131, the reel device M1, and the lower image display panel 701 perform displaying as shown in FIG. 23.

(Images of Bonus Game: When Winning Results in Continued Random Determination, and in Payout Upgrading Random Determination for Upgrading from 4 of a Kind to 5 of a Kind)

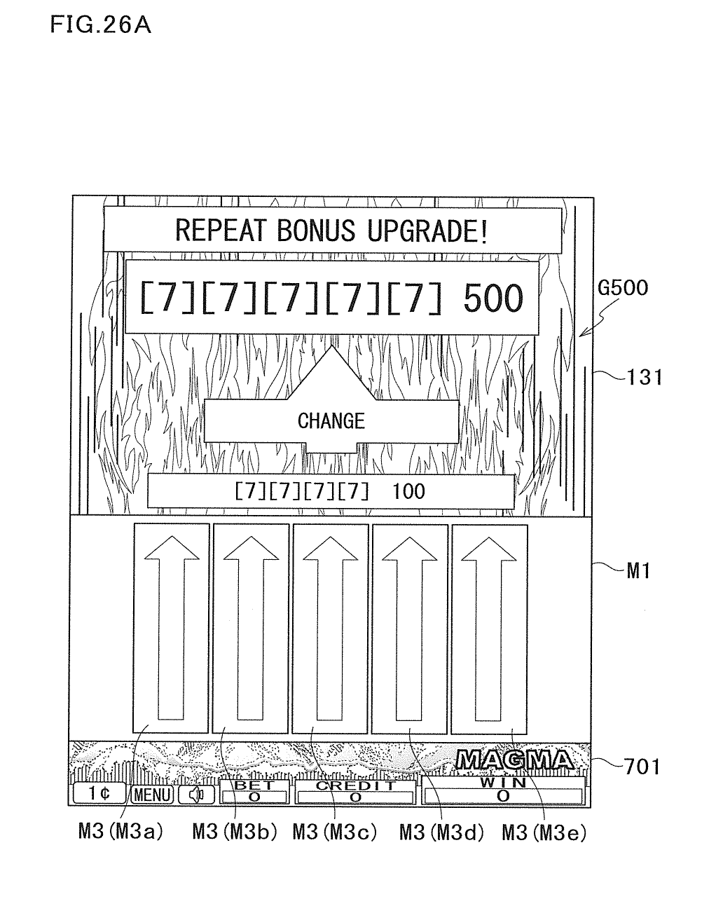

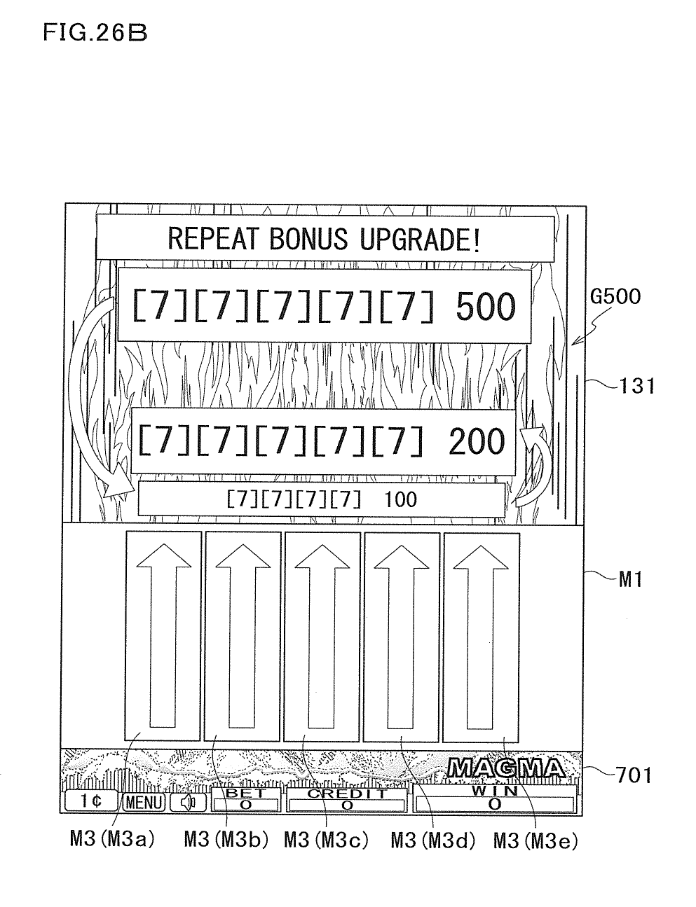

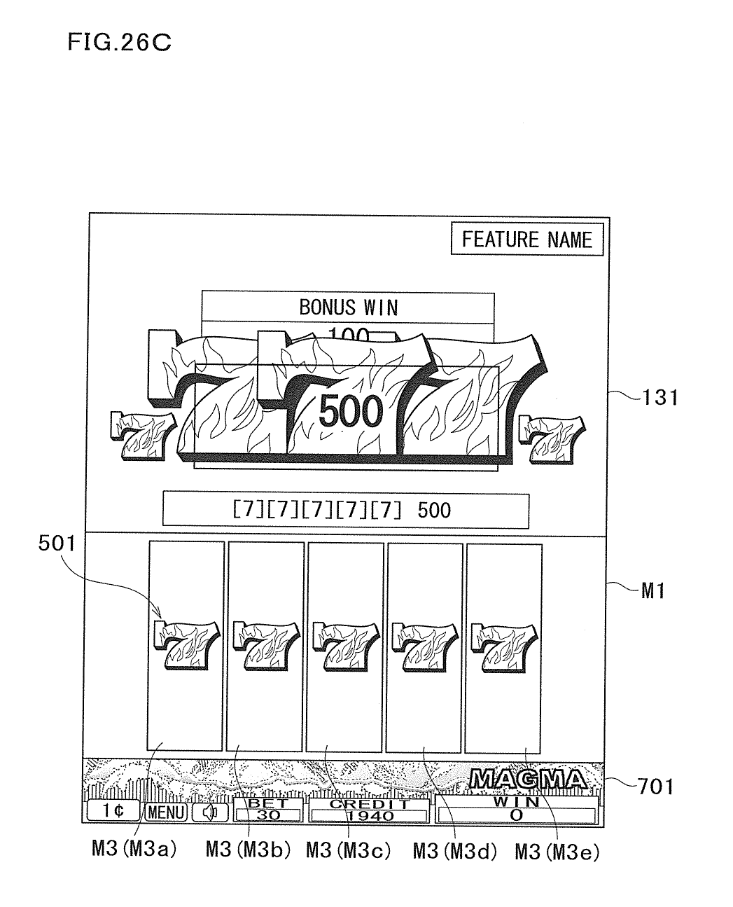

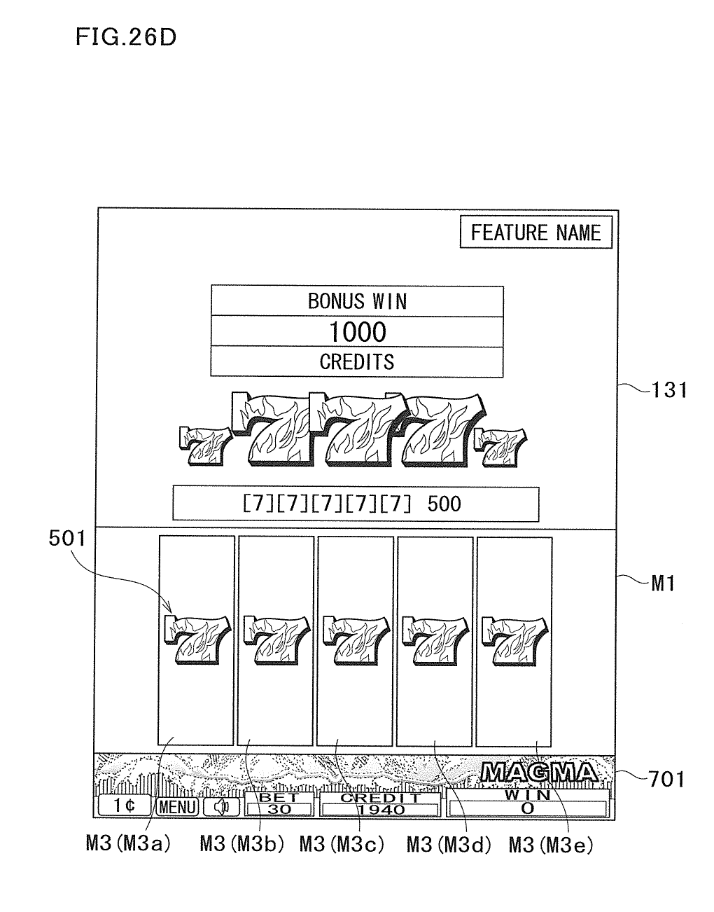

The following describes displays on the upper image display panel 131, the reel device M1, and the lower image display panel 701, when the payout upgrading random determination for upgrading from the 4 of a kind to the 5 of a kind results in winning, with reference to FIG. 26A, FIG. 26B, FIG. 26C, and FIG. 26E. Displays up to the one shown in FIG. 25A are the same as those in cases of winning the payout upgrading random determination for upgrading from the 3 of a kind to the 4 of a kind. After the display as shown in FIG. 25A, an image as shown in FIG. 26A indicating that the upgrading from the 4 of a kind combination to the 5 of a kind combination of “SEVEN(7)” occurred is displayed on the upper image display panel 131. Then, displaying of the 5 of a kind combination of “SEVEN(7)” replaces that of the 4 of a kind combination of “SEVEN(7)”, as indicated by the arrow in FIG. 26B, and displaying of the 5 of a kind combination of “SEVEN(7)” is moved slightly upward. Then, as shown in FIG. 26C, a certain number of “SEVEN(7)” symbols corresponding to the selected bonus type are stop-displayed on the reel device M1, and the payout amount corresponding to the selected bonus type is indicated and emphasized on the upper image display panel 131. The display is as shown in FIG. 26D, when the second payout is awarded. Then, the upper image display panel 131, the reel device M1, and the lower image display panel 701 perform displaying as shown in FIG. 23.

(Images of Bonus Game: When Winning does not Result in Continued Random Determination)

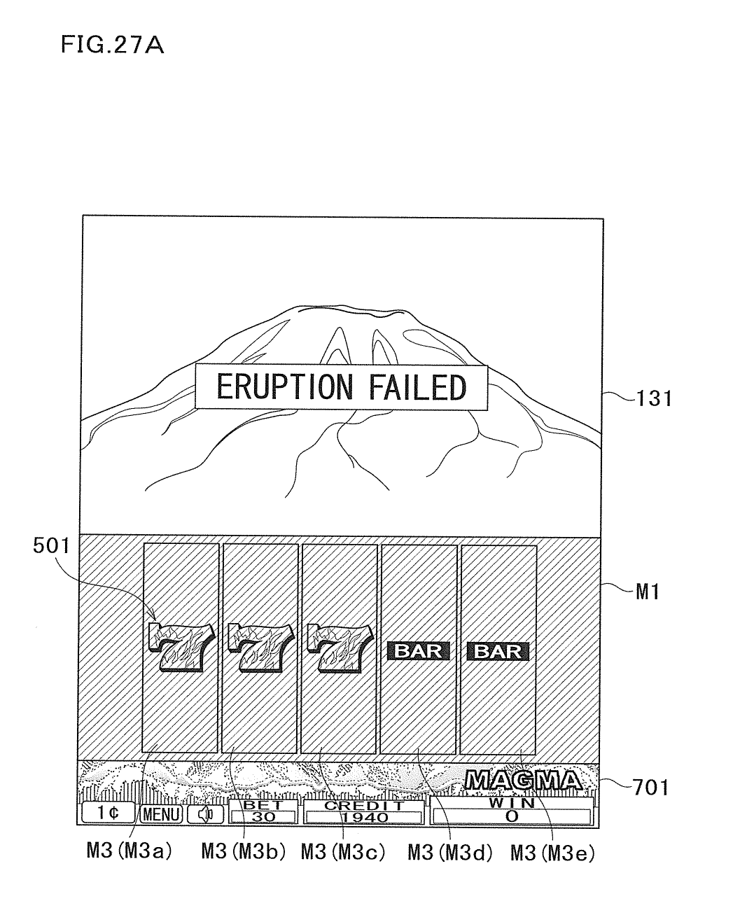

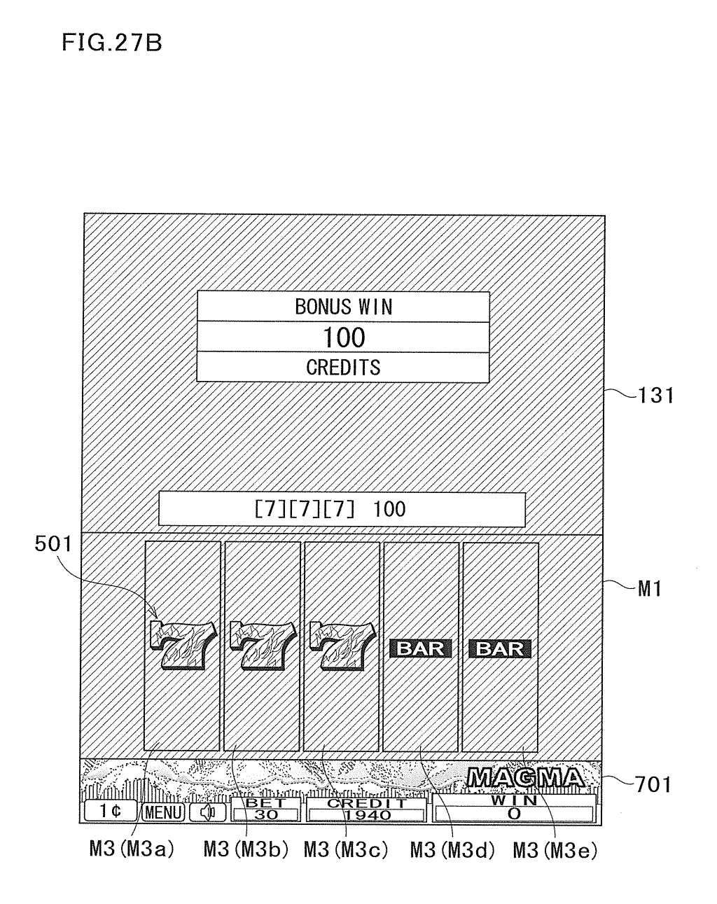

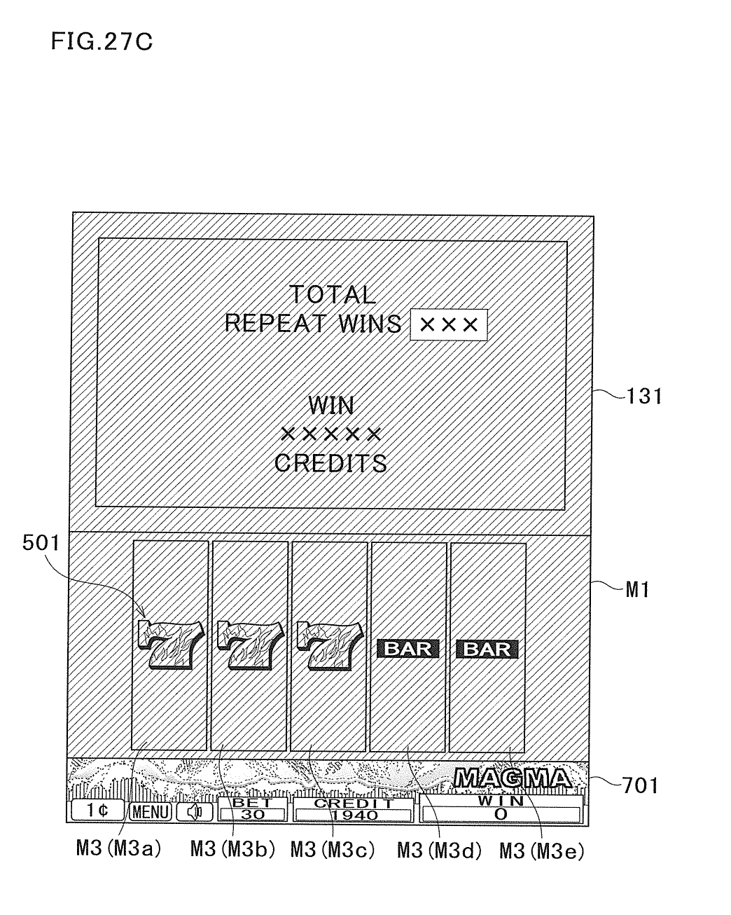

The following describes displays on the upper image display panel 131, the reel device M1, and the lower image display panel 701, when continued random determination does not result in winning, with reference to FIG. 27A, FIG. 27B, and FIG. 27C. As shown in FIG. 27A, a background image depicting that the volcano did not erupt is displayed on the upper image display panel 131, the display on the transparent liquid crystal panel on the reel device M1 is blacked out. Then, as shown in FIG. 27B, the upper image display panel 131 is also partially blacked out except for a portion, and the total second payout awarded in the bonus game is displayed on the upper image display panel as shown in FIG. 27C (display except for the total amount is blacked out). Then, the upper image display panel 131, the reel device M1, and the lower image display panel 701 perform displaying of the normal game.

(Effect Image Displayed on Upper Image Display Panel)

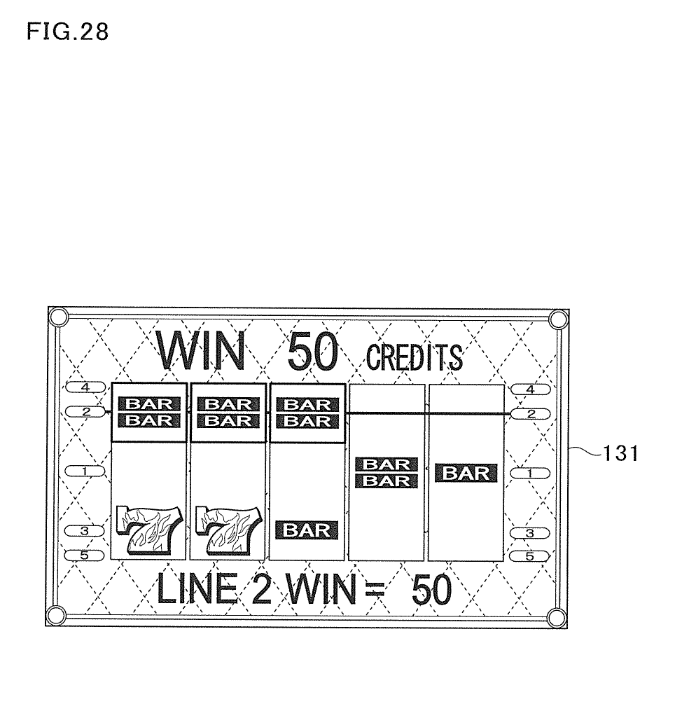

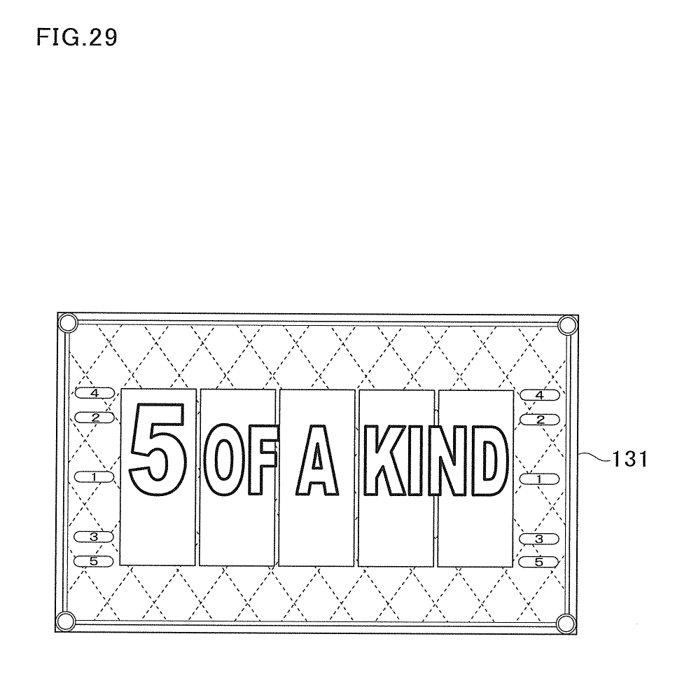

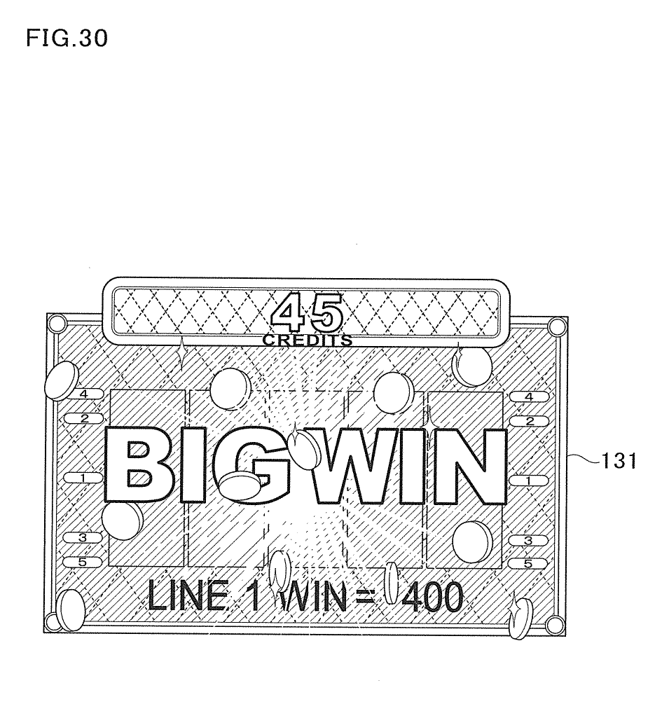

The following describes the effect image displayed on the upper image display panel 131, with reference to FIG. 28, FIG. 29, and FIG. 30. FIG. 28 is an effect image displayed in the normal game. FIG. 29 is an effect image displayed when the 5 of a kind combination of any symbol 501 is stop-displayed. FIG. 30 is an effect image displayed at a time of big win.

(Modification)

The present embodiment deals with a case where when the player guided by an image shown in FIG. 23 for example presses the spin button 46, the continued random determination and the payout upgrading random determination for a plurality of bonuses are executed successively to obtain results for the bonuses. However, such a function does not have to be necessarily provided. For example, it is possible to adopt a structure such that, when the spin button 46 is pressed, the continued random determination and the payout upgrading random determination for a single bonus is executed, and the predetermined symbol displaying process and the second payout process are executed based on the results of these random determinations, and when the spin button 46 is pressed again, the continued random determination and the payout upgrading random determination for another bonus is executed, and the predetermined symbol displaying process and the second payout process are executed based on the results of these random determinations. That is, the structure may be such that the continued random determination and the payout upgrading random determination are executed only for a single bonus, when the spin button 46 is pressed, and the predetermined symbol displaying process and the second payout process are executed immediately based on the results of the random determinations. Further, it is possible to enable switching to such a structure by changing the setting of the number of continued random determination executed in the bonus awarding process of FIG. 20A to one. Further, changing of the setting may be done by operation of a switch (a switch provided to the gaming machine 1), which enables the player to operate from outside.

Embodiments of the present invention thus described above solely serve as specific examples of the present invention, and are not to limit the scope of the present invention. The specific structures and the like are suitably modifiable. Further, the effects described in the embodiments of the present invention described in the above embodiment are no more than examples of preferable effects brought about by the present invention, and the effects of the present invention are not limited to those described hereinabove.

Further, the detailed description above is mainly focused on characteristics of the present invention to fore the sake of easier understanding. The present invention is not limited to the above embodiments, and is applicable to diversity of other embodiments. Further, the terms and phraseology used in the present specification are adopted solely to provide specific illustration of the present invention, and in no case should the scope of the present invention be limited by such terms and phraseology. Further, it will be obvious for those skilled in the art that the other structures, systems, methods or the like are possible, within the spirit of the present invention described in this specification. The description of claims therefore shall encompass structures equivalent to the present invention, unless otherwise such structures are regarded as to depart from the spirit and scope of the present invention. Further, the abstract is provided to allow, through a simple investigation, quick analysis of the technical features and essences of the present invention by an intellectual property office, a general public institution, or one skilled in the art who is not fully familiarized with patent and legal or professional terminology. It is therefore not an intention of the abstract to limit the scope of the present invention which shall be construed on the basis of the description of the claims. To fully understand the object and effects of the present invention, it is strongly encouraged to sufficiently refer to disclosures of documents already made available.

The detailed description of the present invention provided hereinabove includes a process executed on a computer. The above descriptions and expressions are provided to allow the one skilled in the art to most efficiently understand the present invention. A process performed in or by respective steps yielding one result or blocks with a predetermined processing function described in the present specification shall be understood as a process with no self-contradiction. Further, the electrical or magnetic signal is transmitted/received and written in the respective steps or blocks. It should be noted that such a signal is expressed in the form of bit, value, symbol, text, terms, number, or the like solely for the sake of convenience. Although the present specification occasionally personifies the processes carried out in the steps or blocks, these processes are essentially executed by various devices. Further, the other structures necessary for the steps or blocks are obvious from the above descriptions.

### REFERENCE SIGNS LIST

10. Slot Machine
71. Main CPU (Controller)
73. RAM (Storage Unit)
150. Display Window
501. Symbol Display Window
M1. Reel device (Display Device)
P10. Paylines
T1. Symbol Random Determination Table
T2. Bonus Information Table
T3A. Continued Random Determination Table for first Time
T3B. Continued Random Determination Table for 2d Time
G500. Effect Image of Flame

What is claimed is:

1. A gaming machine comprising a storage unit configured to store a symbol random determination table to which a plurality of types of symbols are registered, a display device, and a controller,
the controller configured to execute the following steps of: (A) executing a first random determination for determining symbols to be displayed on the display device, based on the symbol random determination table; (B) displaying the symbols determined in the step (A) on the display device; (C) executing a second random determination different from the first random determination, which determines whether to display a predetermined symbol on the display device; and (D) performing displaying of the predetermined symbol on the display device, based on the result of the step (C).

2. The gaming machine according to claim 1, wherein the controller is configured to execute the following steps of: (E) awarding a first payout based on the symbols determined in the step (A); and (F) awarding a second payout based on the predetermined symbol determined in the step (C).

3. The gaming machine according to claim 2, wherein the controller
repeats the step (C) until the predetermined symbol is determined as not to be displayed on the display device by the second random determination, and repeats the step (D) and the step (F) a number of times the step (C) is executed.
when the steps (C), (D), (F) are to be repeated, executes the step (D) of an n-th (where n>0) time based on the result of the second random determination in the step (C) of the n-th time, and execute the step (F) of the n-th time based on the predetermined symbol determined in the step (C) of the n-th time.

4. The gaming machine according to claim 3, wherein the steps (C), (D), and (F) are executed in a bonus game,
one bonus type is selected, from a plurality of bonus types associated with different amounts of payout, and set as a selected bonus type,
the controller
awards the second payout based on the amount of payout corresponding to the selected bonus type set in the step (F), and further executes the steps of: (I) executing a third random determination every time the step (C) is executed, to determine whether to make a transition from the set selected bonus type to another bonus type associated with an amount of payout higher than the set selected bonus type; and (J) setting said another bonus type as the selected bonus type when the transition to said another bonus type is determined as to be made in the third random determination.

5. The gaming machine according to claim 4, wherein, in the step (I), the third random determination to determine whether to make a transition to said another bonus type is executed from execution of the step (C) for the second time and every time the step (C) is executed thereafter, and the third random determination is not executed in a period between execution of the step (C) for the first time to execution of the step (C) for the second time.

6. The gaming machine according to claim 3, wherein the step (C) is repeated until the predetermined symbol is determined as not to be displayed on the display device by the second random determination, and then the step (D) and the step (F) are repeated a number of times the step (C) is executed.

7. The gaming machine according to claim 4, wherein: the step (C) is executed when a specific symbol is included in the symbols displayed in the step (B), and that the step (C) is a process of determining by the second random determination whether to display the specific symbol as the predetermined symbol on the display device;
the plurality of bonus types each is associated with the number of specific symbols; and
the display device displays the same number of specific symbols as the number associated with the set selected bonus type in the step (D).

8. The gaming machine according to claim 1, wherein a plurality of paylines are arranged in a symbol display area of the display device, and the plurality of paylines include at least three paylines aligned in a vertical direction; and
the step (C) is executed when a specific symbol is displayed in a position corresponding to at least one of the plurality of paylines, and that the step (C) is a process of determining by the second random determination whether to display the specific symbol as the predetermined symbol on the display device; and
in the step (D), the specific symbol is displayed in a position corresponding to a payline out of the at least three paylines other than the uppermost or lowermost payline, and no specific symbol is displayed in positions corresponding to the uppermost or lowermost payline.

9. The gaming machine according to claim 4, wherein the plurality of different types of bonus are associated with different modes of effects, respectively;
(K) providing an effect associated with the set selected bonus type, prior to the step (D).

10. A game control method for a gaming machine comprising a storage unit configured to store a symbol random determination table, a display device, and a controller, comprising the steps of: (A) executing a first random determination for determining symbols to be displayed on the display device, based on the symbol random determination table; (B) displaying the symbols determined in the step (A) on the display device; (C) executing a second random determination different from the first random determination, which determines whether to display a predetermined symbol on the display device; and (D) performing displaying of the predetermined symbol on the display device, based on the result of the step (C).

11. The gaming machine according to claim 5, wherein: the step (C) is executed when a specific symbol is included in the symbols displayed in the step (B), and that the step (C) is a process of determining by the second random determination whether to display the specific symbol as the predetermined symbol on the display device;
the plurality of bonus types each is associated with the number of specific symbols; and
the display device displays the same number of specific symbols as the number associated with the set selected bonus type in the step (D).

12. The gaming machine according to claim 2, wherein a plurality of paylines are arranged in a symbol display area of the display device, and the plurality of paylines include at least three paylines aligned in a vertical direction; and
the step (C) is executed when a specific symbol is displayed in a position corresponding to at least one of the plurality of paylines, and that the step (C) is a process of determining by the second random determination whether to display the specific symbol as the predetermined symbol on the display device; and
in the step (D), the specific symbol is displayed in a position corresponding to a payline out of the at least three paylines other than the uppermost or lowermost payline, and no specific symbol is displayed in positions corresponding to the uppermost or lowermost payline.

13. The gaming machine according to claim 3, wherein a plurality of paylines are arranged in a symbol display area of the display device, and the plurality of paylines include at least three paylines aligned in a vertical direction; and
the step (C) is executed when a specific symbol is displayed in a position corresponding to at least one of the plurality of paylines, and that the step (C) is a process of determining by the second random determination whether to display the specific symbol as the predetermined symbol on the display device; and
in the step (D), the specific symbol is displayed in a position corresponding to a payline out of the at least three paylines other than the uppermost or lowermost payline, and no specific symbol is displayed in positions corresponding to the uppermost or lowermost payline.

14. The gaming machine according to claim 4, wherein a plurality of paylines are arranged in a symbol display area of the display device, and the plurality of paylines include at least three paylines aligned in a vertical direction; and
the step (C) is executed when a specific symbol is displayed in a position corresponding to at least one of the plurality of paylines, and that the step (C) is a process of determining by the second random determination whether to display the specific symbol as the predetermined symbol on the display device; and
in the step (D), the specific symbol is displayed in a position corresponding to a payline out of the at least three paylines other than the uppermost or lowermost payline, and no specific symbol is displayed in positions corresponding to the uppermost or lowermost payline.

15. The gaming machine according to claim 5, wherein a plurality of paylines are arranged in a symbol display area of the display device, and the plurality of paylines include at least three paylines aligned in a vertical direction; and
the step (C) is executed when a specific symbol is displayed in a position corresponding to at least one of the plurality of paylines, and that the step (C) is a process of determining by the second random determination whether to display the specific symbol as the predetermined symbol on the display device; and
in the step (D), the specific symbol is displayed in a position corresponding to a payline out of the at least three paylines other than the uppermost or lowermost payline, and no specific symbol is displayed in positions corresponding to the uppermost or lowermost payline.

16. The gaming machine according to claim 6, wherein a plurality of paylines are arranged in a symbol display area of the display device, and the plurality of paylines include at least three paylines aligned in a vertical direction; and
the step (C) is executed when a specific symbol is displayed in a position corresponding to at least one of the plurality of paylines, and that the step (C) is a process of determining by the second random determination whether to display the specific symbol as the predetermined symbol on the display device; and
in the step (D), the specific symbol is displayed in a position corresponding to a payline out of the at least three paylines other than the uppermost or lowermost payline, and no specific symbol is displayed in positions corresponding to the uppermost or lowermost payline.

17. The gaming machine according to claim 7, wherein a plurality of paylines are arranged in a symbol display area of the display device, and the plurality of paylines include at least three paylines aligned in a vertical direction; and
the step (C) is executed when a specific symbol is displayed in a position corresponding to at least one of the plurality of paylines, and that the step (C) is a process of determining by the second random determination whether to display the specific symbol as the predetermined symbol on the display device; and
in the step (D), the specific symbol is displayed in a position corresponding to a payline out of the at least three paylines other than the uppermost or lowermost payline, and no specific symbol is displayed in positions corresponding to the uppermost or lowermost payline.

18. The gaming machine according to claim 11, wherein a plurality of paylines are arranged in a symbol display area of the display device, and the plurality of paylines include at least three paylines aligned in a vertical direction; and
the step (C) is executed when a specific symbol is displayed in a position corresponding to at least one of the plurality of paylines, and that the step (C) is a process of determining by the second random determination whether to display the specific symbol as the predetermined symbol on the display device; and
in the step (D), the specific symbol is displayed in a position corresponding to a payline out of the at least three paylines other than the uppermost or lowermost payline, and no specific symbol is displayed in positions corresponding to the uppermost or lowermost payline.

19. The gaming machine according to claim 5, wherein the plurality of different types of bonus are associated with different modes of effects, respectively;
(K) providing an effect associated with the set selected bonus type, prior to the step (D).

20. The gaming machine according to claim 6, wherein the plurality of different types of bonus are associated with different modes of effects, respectively;
(K) providing an effect associated with the set selected bonus type, prior to the step (D).
